(19) United States
(12) Patent Application Publication
(10) Pub. No.: US 2026/0264989 A1
(43) Pub. Date: Sep. 10, 2026

(54) Carry System, Control Apparatus, and Control Method

(71) Applicant: Hitachi, Ltd., Chiyoda-ku, Tokyo (JP)

(72) Inventors: Akiharu IKEDA, Tokyo (JP); Takuya WADA, Tokyo (JP); Satoshi NAGAHARA, Tokyo (JP); Yukihiro OKADA, Tokyo (JP); Tetsuya ABE, Tokyo (JP)

(21) Appl. No.: 19/165,198

(22) PCT Filed: May 9, 2024
(86) PCT No.: PCT/JP2024/017193

§ 371 Date: Sep. 15, 2025

(30) Foreign Application Priority Data
May 30, 2023 (JP) 2023-089130

(51) Int. Cl. B65G 1/137; G06Q 10/087

(52) U.S. Cl. CPC B65G 1/1378; G06Q 10/087

(57) ABSTRACT

When a plurality of articles corresponding to a first order is arranged in two or more storage areas, a control apparatus selects a first storage area in which a part of the articles corresponding to the first order is arranged, controls material handling equipment of the first storage area so that the part of the articles is moved out from the first storage area, specifies a carry destination WS that is a work station to which the part of the articles is moved out, and controls the first carry apparatus on which the first order container corresponding to the first order is loaded so as to move to a stop area corresponding to the carry destination WS. After the part of articles are placed in the first order container, the control apparatus controls the first carry apparatus so as to move to a stop area corresponding to a second storage area in which another part of the articles corresponding to the first order is arranged.

### TECHNICAL FIELD

The present invention generally relates to a technique for conveying a conveyed article by traveling of a carry apparatus.

### BACKGROUND ART

As background art in the present technical field, there is a technique related to “an product sorting system provided with a plurality of product collection lines constituted by providing product collecting conveyors along storage areas for storing products to be collected, each of the plurality of product collection lines being configured to perform picking that is work to take out necessary products from the storage area by pickers and input the products in product collecting containers conveyed along the product collecting conveyor so as to sort and collect the products for purchasers”. For example, there is the technique described in Patent Literature 1.

### CITATION LIST

### Patent Literature

[Patent Literature 1] Japanese Patent Laid-Open No. 2007-182290

### SUMMARY OF INVENTION

### Technical Problem

At logistics centers, picking articles (for example, products) corresponding to orders from each storage area and sorting them into packing units is high-load work. In particular, while the EC market continues to expand, problems such as a shortage of workers at logistics centers have arisen and there is a strong need to reduce workload.

In consideration thereof, a system is provided which is capable of reducing a workload of sorting work even when storage positions of a plurality of articles corresponding to an order straddle a plurality of areas.

### Solution to Problem

A control apparatus stores inventory information including information about the inventory of articles arranged in each of a plurality of storage areas that differ in at least one of a storage scheme, an outbound movement scheme, and a picking scheme. Each of the plurality of storage areas includes one or more work stations (WSs) and one or more stop areas. Each of the one or more WSs is an area that may become an outbound movement destination of articles from the storage area to which the WS is associated and where work of picking the moved articles and/or placing the picked articles into an order container is performed. Each of the one or more stop areas is an area where carry apparatuses stop. One or more storage areas among the plurality of storage areas include material handling equipment. The control apparatus communicates with the material handling equipment of the one or more storage areas and a plurality of carry apparatuses including a first carry apparatus on which a first order container corresponding to a first order is loaded. When it is identified from the inventory information that a plurality of articles corresponding to the first order is arranged in two or more storage areas among the plurality of storage areas, the control apparatus selects a first storage area in which a part of the articles corresponding to the first order is arranged among the two or more storage areas, controls the material handling equipment of the first storage area so that the part of the articles corresponding to the first order is moved out from the first storage area, identifies a carry destination WS that is a WS to which the part of the articles is moved out, and controls the first carry apparatus on which the first order container corresponding to the first order is loaded so as to move to a stop area corresponding to the carry destination WS. After the part of articles having moved out are placed in the first order container loaded on the first carry apparatus, the control apparatus controls the first carry apparatus so as to move to a stop area corresponding to a second storage area in which another part of the articles corresponding to the first order is arranged.

### Advantageous Effects of Invention

According to the present invention, a workload of sorting work can be reduced even when storage positions of a plurality of articles corresponding to an order straddle a plurality of areas. Problems, configurations, and effects other than those described above will become apparent in the following description of embodiments of the invention.

### BRIEF DESCRIPTION OF DRAWINGS

FIG. 1 is a diagram showing an outline of a plurality of types of areas according to an embodiment.

FIG. 2 is an explanatory diagram of a configuration of a movement area.

FIG. 3A is a diagram showing an example of a carry apparatus and loading to the carry apparatus.

FIG. 3B is a diagram showing another example of a carry apparatus and loading to the carry apparatus.

FIG. 4A is a schematic view showing an example of a flat-loaded area.

FIG. 4B is a schematic view showing an example of an automated warehouse area.

FIG. 4C is a schematic view showing an example of a shelf carry area.

FIG. 4D is a schematic view showing an example of a movable shelf area.

FIG. 5 is a schematic view showing an example of a packing area.

FIG. 6 is a diagram showing a part of a specific configuration example of elements in a carry system.

FIG. 7 is a diagram showing a remainder of the specific configuration example of elements in a carry system.

FIG. 8 is a diagram showing a configuration example of an order table.

FIG. 9 is a diagram showing a configuration example of an inventory table.

FIG. 10 is a diagram showing a configuration example of a storage area table.

FIG. 11 is a diagram showing a configuration example of a carry apparatus table.

FIG. 12 is a diagram showing a configuration example of a movement area table.

FIG. 13 is a diagram showing a configuration example of a shipping box table.

FIG. 14 is a diagram showing a configuration example of a loading work management table.

FIG. 15 is a diagram showing a configuration example of a picking work management table.

FIG. 16 is a flow chart showing a part of a flow of order processing.

FIG. 17 is a flow chart showing a part of a flow of order processing.

FIG. 18 is a flow chart showing a part of a flow of order processing.

FIG. 19 is a flow chart showing a part of a flow of order processing.

FIG. 20 is a flow chart showing a part of a flow of order processing.

FIG. 21 is a flow chart showing a part of a flow of order processing.

FIG. 22 is a flow chart showing a flow of shipping box selection processing.

### DESCRIPTION OF EMBODIMENT

In the following description, an “interface apparatus” may be one or more interface devices. The one or more interface devices may be at least one of the following.

One or more I/O (Input/Output) interface devices. Each I/O (Input/Output) interface device is an interface device with respect to at least any of an I/O device and a remote display computer. The I/O interface device with respect to the display computer may be a communication interface device. At least one I/O device may be a user interface device, for example any of an input device such as a keyboard and a pointing device and an output device such as a display device.

One or more communication interface devices. The one or more communication interface devices may be one or more of a same type of communication interface device (for example, one or more NICs (Network Interface Cards)) or two or more of different types of communication interface devices (for example, an NIC and an HBA (Host Bus Adapter)).

In addition, in the following description, a “memory” may be one or more memory devices that are an example of one or more storage devices and may typically be a main storage device. The at least one memory device in the memory may be a volatile memory device or a non-volatile memory device.

In addition, in the following description, a “persistent storage apparatus” may be one or more persistent storage devices that are an example of one or more storage devices. Typically, the persistent storage device may be a non-volatile storage device (such as an auxiliary storage device) and a specific example thereof may be an HDD (Hard Disk Drive), an SSD (Solid State Drive), an NVME (Non-Volatile Memory Express) drive, or an SCM (Storage Class Memory).

In addition, in the following description, a “storage apparatus” may be a “memory” and/or a “persistent storage apparatus”.

In addition, in the following description, a “processor” may be one or more processor devices. The at least one processor device may typically be a microprocessor device such as a CPU (Central Processing Unit) or another type of processor device such as a GPU (Graphics Processing Unit). The at least one processor device may be single core or multi-core. The at least one processor device may be a processor core. The at least one processor device may be a processor device in the broad sense of the term such as a circuit (for example, an FPGA (Field-Programmable Gate Array), a CPLD (Complex Programmable Logic Device), or an ASIC (Application Specific Integrated Circuit)) which is a collection of gate arrays based on a hardware description language and which performs a part of or all of the processing.

In addition, although information that enables an output to be obtained in response to an input will be described below using expressions such as an “xxx table”, the information may be data of any structure (including structured data or unstructured data) or may be a machine learning model such as a neural network that generates an output with respect to an input, a genetic algorithm, or a random forest. Therefore, an “xxx table” can be referred to as “xxx information”. In addition, in the following description, the configuration of each table is merely an example and a single table may be divided into two or more tables or all of or a part of two or more tables may constitute a single table.

In addition, in the following description, while processing may be described using a “program” as a subject, since the program performs prescribed processing using the storage apparatus and/or an interface apparatus as appropriate by being executed by the processor, the processor (or a computer, an apparatus, or a system that includes the processor) may be considered the subject of the processing. The program may be installed onto an apparatus such as a computer from a program source. For example, the program source may be a program distribution server or a computer-readable recording medium (for example, a non-transitory recording medium). In addition, in the following description, two or more programs may be realized as one program or one program may be realized as two or more programs.

In addition, any information (for example, at least one of an “ID”, a “name”, and a “number”) may be adopted as information (identification information, identifier) for identifying an element.

In addition, in the following description, common signs among reference signs may be used when describing elements of a same kind without distinction but reference signs may be used when distinguishing elements of a same kind from one another.

In addition, in the following description, the unit of “date and time” may be a unit that is coarser or finer than year, month, day, hour, and minute.

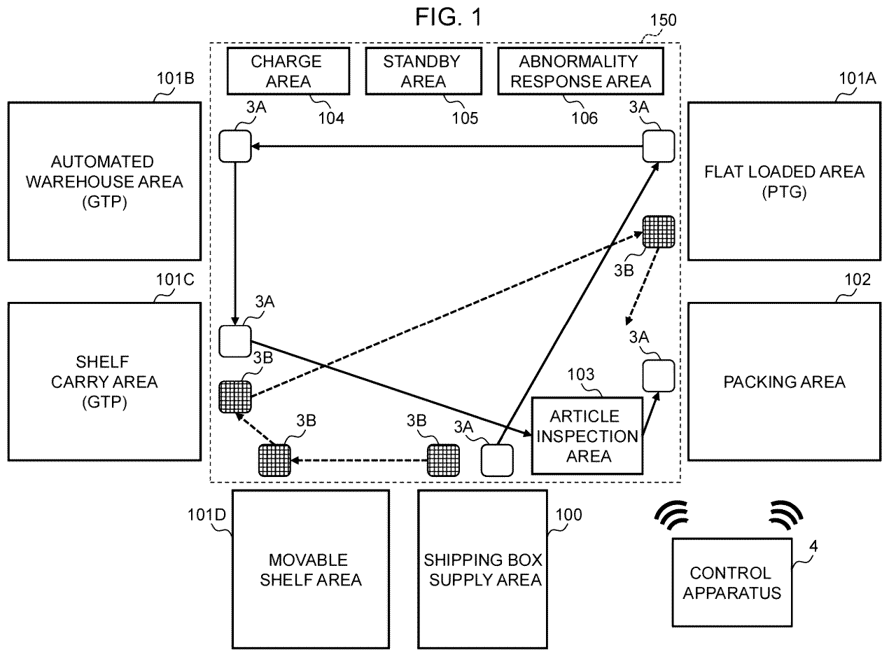

FIG. 1 is a diagram showing an outline of a plurality of types of areas according to an embodiment. The plurality of types of areas shown in FIG. 1 may be a part of, for example, a logistics facility (such as a warehouse or a logistics center). For example, a logistics facility is a storage used by a company such as a mail-order company or an equipment manufacturer in order to store articles. The articles stored in the logistics facility may be products or components.

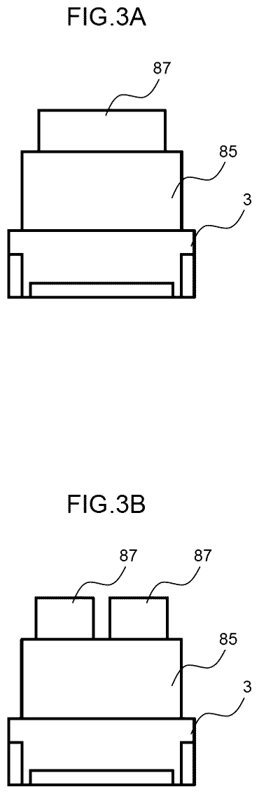

The carry system includes a plurality of carry apparatuses 3 that travel in a movement area 150 and a control apparatus 4 that remotely controls movement of each carry apparatus 3. A shipping box 87 (refer to FIGS. 3A and 3B) is loaded on the carry apparatus 3 and an article (for example, a commodity or a component) is placed inside the shipping box 87. The “shipping box 87” is a container (for example, a box) in which articles to be packed in a same box (for example, a cardboard box) are placed as a shipping unit (packing unit) and may be referred to as an “order container”. Articles to be packed in different boxes as shipping units are not placed in the same shipping box 87 and are each placed in a shipping box 87 corresponding to each shipping unit. Once the articles are ready in the shipping box 87, the articles in the shipping box 87 are inspected, packed, and then shipped. The articles in the shipping box 87 may be transferred to a box to be shipped (for example, a cardboard box) by a worker or a work robot and subsequently packed and shipped. Alternatively, the shipping box 87 may be the box to be shipped itself.

The movement area 150 includes an article inspection area 103, a charge area 104, a standby area 105, and an abnormality response area 106. The article inspection area 103 is an area where articles in the shipping box 87 loaded on the carry apparatus 3 are inspected. The charge area 104 is an area where the carry apparatus 3 is charged. The standby area 105 is an area where the carry apparatus 3 stands by. The abnormality response area 106 is an area where an abnormality having occurred in the carry apparatus 3 is dealt with. At least one of the areas 103 to 106 may be located outside of the movement area 150. In addition, another area may be provided inside or outside the movement area 150 in place of or in addition to at least one of the areas 103 to 106. Furthermore, while article inspection is performed in the present embodiment when the carry apparatus 3 passes through the article inspection area 103 in the movement area 150, alternatively, article inspection may be performed after articles are handed over to a packing area 102 (in this case, the movement area 150 need not include the article inspection area 103 and the packing area 102 may double as an article inspection area).

A shipping box supply area 100, a plurality of storage areas 101, and the packing area 102 are located outside of the movement area 150. The shipping box supply area 100 is an area to which the shipping box 87 is supplied and the shipping box 87 is loaded on the carry apparatus 3. While an empty shipping box 87 is supplied in the shipping box supply area 100 in the present embodiment, for example, the shipping box 87 may be supplied in a state where a part of the articles to be packed in a same box as a shipping unit are placed in the shipping box 87 such as supplying the shipping box 87 in a state where articles acquired outside of the carry system are inside the shipping box 87. The storage areas 101 are areas where article are stored (placed). The packing area 102 is an area where the shipping box 87 containing articles is packed.

The plurality of storage areas 101 differ in at least one of a storage scheme, an outbound movement scheme, and a picking scheme. Examples of the plurality of storage areas 101 include a flat-loaded area 101A, an automated warehouse area 101B, a shelf carry area 101C, and a movable shelf area 101D. The storage areas 101A to 101D will be described later.

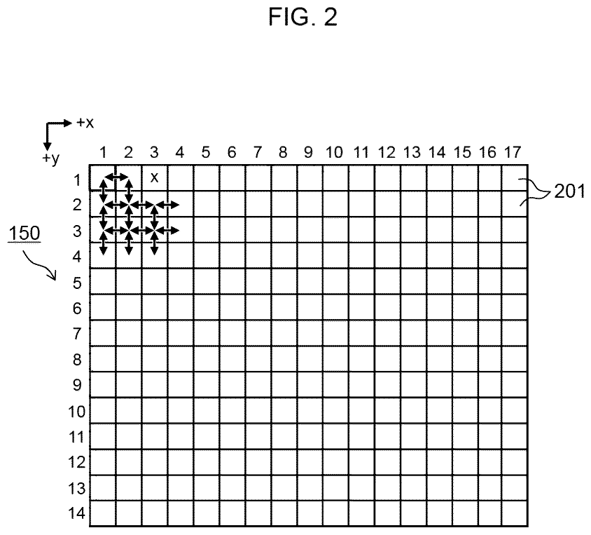

FIG. 2 is an explanatory diagram of a configuration of the movement area 150. Note that an x direction and a y direction orthogonal to the x direction will be adopted as two-dimensional directions for the sake of convenience.

The movement area 150 may be managed by being divided into a plurality of square-shaped sections 201 of predetermined size. Each section 201 can be expressed as section (α, β). α denotes an x coordinate (a section position in the x direction) and β denotes a y coordinate (a section position in the y direction).

For example, when the movement area 150 includes areas of a plurality of floors or upper and lower areas of a mezzanine, an area position in a height direction of each area can be expressed by using a z coordinate. In this case, for example, the section 201 may have a coordinate format such as section (α, β, γ). α denotes an x coordinate (a section position in the x direction), β denotes a y coordinate (a section position in the y direction), and γ denotes a z coordinate (an area position in the height direction). Note that carry between floors when the movement area 150 extends among a plurality of floors or carry between upper and lower parts of a mezzanine when such a mezzanine is provided may be performed by, for example, a vertical conveyor. In this case, only a shipping box may be conveyed by the vertical conveyor or the carry apparatus 3 on which a shipping box is loaded may be conveyed by the vertical conveyor.

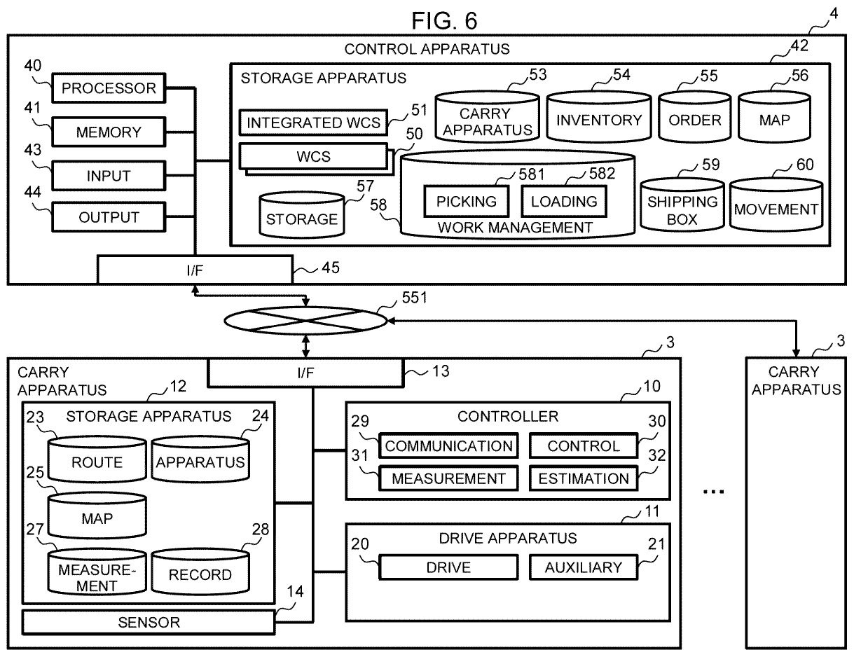

Within each section 201, a marker (not illustrated) representing a position of the section 201 may be marked. The marker need only include information for specifying the position of the section and may be position information of the section or information associated with the position information of the section (for example, identification information of the section 201). The marker is information readable by a sensor 14 (refer to FIG. 6) of the carry apparatus 3 and may be, for example, a one-dimensional code, a two-dimensional code such as a QR code (registered trademark), or information such as an RFID (Radio Frequency Identifier) tag. For example, when the carry apparatus 3 passes each section 201, the carry apparatus 3 reads the marker in the section 201. Each carry apparatus 3 transmits read information of the marker together with the identification information of the carry apparatus 3 to the control apparatus 4. The control apparatus 4 specifies the position of each carry apparatus 3 based on the identification information of the carry apparatus 3 and the information of the marker received from each carry apparatus 3. The entire region of the section 201 has a plate-like member which allows movement from the section 201 to another section 201 adjacent thereto, and the section 201 may enable turning of the carry apparatus 3 inside the section 201.

For example, sizes of the carry apparatus 3 and the shipping box 87 may be smaller than one section 201. There may be various modifications in the way the sections are set up. In addition, a section (for example, section (3, 1)) may be provided into which the carry apparatus 3 must not enter.

For each section 201 of the movement area 150, as shown by arrows illustrated in FIG. 2, a direction in which the conveyor apparatus 3 can move in the section 201 need not be restricted (for example, the +x direction, the −x direction, the +y direction, and the −y direction may all be possible directions for the carry apparatus 3 to move). In addition, spaces between sections 201 may be set up so as to be movable in both directions or only in one direction. For example, by setting a part of the spaces between the sections 201 so as to be movable in only one direction, it is expected that an occurrence of a congestion of the carry apparatuses 3 will be suppressed or reduced and overall movement efficiency will be improved. Furthermore, when there are many spaces between the sections 201 set up to be movable in only one direction, since a movement path of the carry apparatuses 3 may increase, directions in which the carry apparatuses 3 can move may be set in advance or such directions may be dynamically set or changed by the control apparatus 4 depending on the number of carry apparatuses 3 in the movement area 150, the location of each section 201, a section setting 1202, or the like.

Let us now refer again to FIG. 1. The carry apparatus 3 is an apparatus that moves according to a movement instruction from the control apparatus 4 and may typically be an AGV (Automatic Guided Vehicle). For example, in accordance with one or more movement instructions from the control apparatus 4, the carry apparatus 3 starts moving from the shipping box supply area 100 with an empty shipping box 87 loaded thereon, moves to two or more (or one) storage areas 101 respectively, and arrives at the packing area 102 via the article inspection area 103 together with the articles placed in the shipping box 87 from each of the two or more (or one) storage areas 101. Specifically, for example, as illustrated, a movement order of the carry apparatus 3A is shipping box supply area 100→flat-loaded area 101A→automated warehouse area 101B→shelf carry area 101C→article inspection area 103→packing area 102. In addition, as illustrated, a movement order of the carry apparatus 3B is shipping box supply area 100→movable shelf area 101D→shelf carry area 101C→flat-loaded area 101A→article inspection area 103→packing area 102.

When there are orders that designate a plurality of different articles, for each order, the control apparatus 4 allocates one or a plurality of shipping boxes 87 to the order and the one or a plurality of shipping boxes 87 are loaded to one or a plurality of carry apparatuses 3. For example, when all articles corresponding to a given order are packed in a same box as a shipping unit, although the order (all of the articles corresponding to the order) may be allocated to one shipping box 87, the order may be allocated to a plurality of shipping boxes 87 if the order does not fit into the same shipping box 87 or the like. The control apparatus 4 prevents one shipping box 87 from being allocated to a plurality of orders with different delivery destinations. A movement order from the shipping box supply area 100 to the packing area 102 may be designated in one movement instruction or may be an order determined by a combination of a plurality of movement instructions. Note that information representing a movement task allocated to the carry apparatus 3 is associated with a “movement instruction” transmitted to the carry apparatus 3. Note that in the present embodiment, a “movement” of the carry apparatus 3 represents the movement of the carry apparatus 3 in general, regardless of the presence or absence of transported articles (the shipping box 87 or articles in the shipping box 87). A “movement” of the carry apparatus 3 may be paraphrased as “traveling” of the carry apparatus 3. A “movement” of the carry apparatus 3 in a state where the carry apparatus 3 has a conveyed article is sometimes specifically referred to as “carry”. A movement task is a task of moving the carry apparatus 3 to an area designated by the movement task (movement instruction) and may include a task of causing the carry apparatus 3 to convey the shipping box 87 to the designated area. For example, the information representing a movement task may include a movement path which is the route that the carry apparatus 3 travels and a direction of movement of the carry apparatus 3.

As shown in FIG. 3A, the carry apparatus 3 includes a table 85 and the shipping box 87 is loaded onto the table 85. One shipping box 87 may be loaded onto one carry apparatus 3 as shown in FIG. 3A or a plurality of (two or more) shipping boxes 87 may be loaded onto one carry apparatus 3 as shown in FIG. 3B.

When a remaining level of an on-board battery (not illustrated) of the carry apparatus 3 falls below a predetermined value, the carry apparatus 3 moves to the charge area 104 to automatically charge the battery. For example, when the remaining level of the battery of the carry apparatus 3 falls below a predetermined value, the carry apparatus 3 may make a charge request to the control apparatus 4 and the control apparatus 4 may instruct the carry apparatus 3 to move to the charge area 104 to be charged in response to the charge request.

Hereinafter, the plurality of storage areas 101A to 101D will be described. Note that in the description, the “stop area” of each storage area 101 may be an area in the movement area 150 (for example, an area which is adjacent to the storage area 101 and which is constituted of one or more sections 201 of the movement area 150) or an area outside of the movement area 150 (for example, inside the storage area 101).

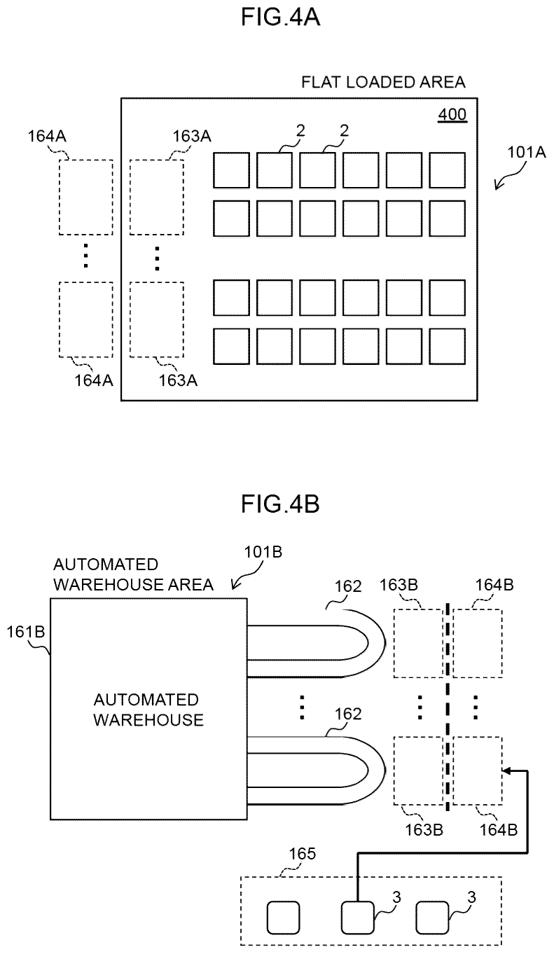

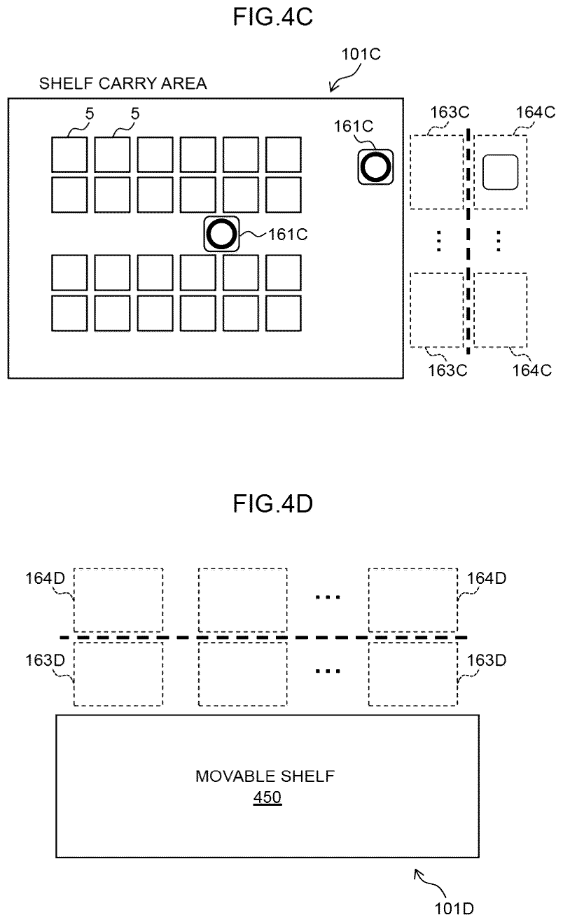

FIG. 4A is a schematic view showing an example of the flat-loaded area 101A.

The flat-loaded area 101A is an example of an area to which PTG (Person To Goods) is applied. According to PTG, a worker (person) walks to a storage location 2 of articles (goods) and picks an article.

The flat-loaded area 101A includes an article area 400 and one or more work areas 163A and each work area 163A is provided with a stop area 164A adjacent to the work area 163A. The article area 400 is an area including each storage location 2 where articles are flat-loaded. The article area 400 may be provided with shelves as the storage locations 2 and articles may be placed on the shelves. The stop area 164A is an area where the carry apparatus 3 stops. In the work area 163A, according to a work instruction from the control apparatus 4, an article picked from the storage location 2 is placed by a worker in (loaded by a worker to) the shipping box 87 of the carry apparatus 3 parked in the stop 164A adjacent to the work area 163A.

FIG. 4B is a schematic view showing an example of the automated warehouse area 101B.

The automated warehouse area 101B is an example of an area to which GTP (Goods To Person) is applied. According to GTP, articles (goods) are carried to the position of a worker (person) who picks by a robot (or another apparatus).

The automated warehouse area 101B includes an automated warehouse 161B, one or more conveyors 162, and one or more work areas 163B and each work area 163B is provided with a stop area 164B adjacent to the work area 163B. The automated warehouse 161B moves out (performs an outbound movement of) articles to any of the conveyors 162 in accordance with an outbound movement instruction from the control apparatus 4. The conveyor 162 conveys the articles moved out of the automated warehouse 161B to the work area 163B (carry destination WS and/or outbound movement destination WS). The work area 163B is an area where articles conveyed by the conveyor 162 are picked by a worker. The stop area 164B is an area where the carry apparatus 3 stops. In the work area 163B, a picked article is placed by a worker in the shipping box 87 of the carry apparatus 3 parked in the stop 164B adjacent to the work area 163B.

The movement area 150 may or may not be provided with a temporary standby area 165 that corresponds to each storage area 101. The temporary standby area 165 that corresponds to each storage area 101 may be provided with a temporary standby area 165 that corresponds to each work area 163, a temporary standby area 165 that corresponds to each stop area 164, or a temporary standby area 165 that corresponds to a plurality of work areas 163 or stop areas 164. Note that in the present embodiment, a temporary standby area 165 that corresponds to the automated warehouse area 101B may be provided. The temporary standby area 165 is an area where the carry apparatus 3 moving to the stop area 164B temporarily stands by. The temporary standby area 165 may be provided near the stop area 164B. For example, when the carry apparatuses 3 are already parked in all of the stop areas 164B, a carry apparatus 3 temporarily stands by at the temporary standby area 165. The temporary standby area 165 may be provided in the automated warehouse area 101B or another storage area 101 in place of or in addition to the movement area 150. In addition, the temporary standby area 165 may be provided inside or outside the storage areas 101. For example, the temporary standby area 165 may be included in the standby area 105.

FIG. 4C is a schematic view showing an example of the shelf carry area 101C.

The shelf carry area 101C is an example of an area to which GTP is applied. In the shelf carry area 101C, a plurality of shelves 5 are arranged and a plurality of articles are placed on the plurality of shelves 5. In the shelf carry area 101C, the carry apparatus 161C conveys a shelf 5 in accordance with an outbound movement instruction (movement instruction) from the control apparatus 4. The shelf carry area 101C includes one or more work areas 163C and each work area 163C is provided with a stop area 164C adjacent to the work area 163C. The work area 163C is an area where articles are picked by a worker from the shelves 5 conveyed by the carry apparatus 161C. The stop area 164C is an area where the carry apparatus 3 stops. In the work area 163C, a picked article is placed by a worker in the shipping box 87 of the carry apparatus 3 parked in the stop area 164C adjacent to the work area 163C.

FIG. 4D is a schematic view showing an example of the movable shelf area 101D.

The movable shelf area 101D includes a movable shelf 450 and one or more work areas 163D and each work area 163D is provided with a stop area 164D adjacent to the work area 163D. The movable shelf 450 has trays arrayed vertically, with articles lined up on each tray. In the work area 163D, according to a work instruction from the control apparatus 4, a worker picks an article from the movable shelf 450 and places the picked article in the shipping box 87 of the carry apparatus 3 parked in the stop area 164D adjacent to the work area 163D.

In this manner, the plurality of storage areas 101A to 101D differ in at least one of a storage scheme, an outbound movement scheme, and a picking scheme.

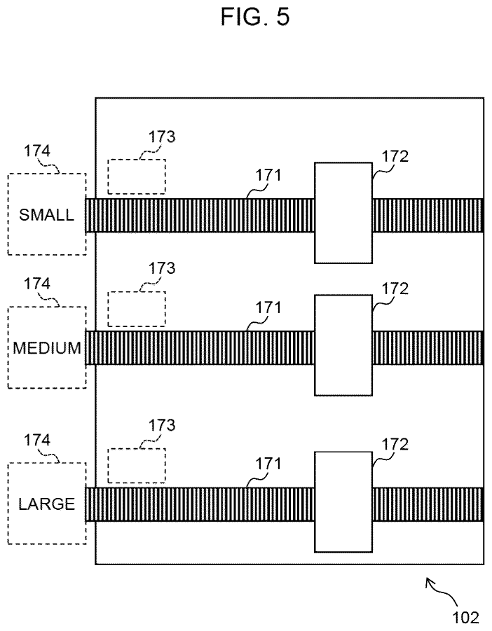

FIG. 5 is a schematic view showing an example of the packing area 102.

The packing area 102 includes one or more conveyors 171 and each conveyor 171 includes a packing machine 172 and a work area 173. In addition, there is a stop area 171 for each conveyor 171. For example, the stop area 174 may be provided for each shipping box size such as large, medium, and small.

For each conveyor 171, the stop area 174 is located in a vicinity of (for example, adjacent to) the work area 173. In the work area 173, a worker transfers the shipping box 87 from the carry apparatus 3 parked in the stop area 174 to the conveyor 171. When the shipping box 87 is a box to be shipped (for example, a cardboard box) itself, the shipping box 87 conveyed by the conveyor 171 is packed by the packing machine 172, and the packed shipping box 87 is conveyed by the conveyor 171 and eventually shipped (delivered). Alternatively, the article placed in the shipping box 87 may be transferred to a box to be shipped (for example, a cardboard box) by a worker, the box to be shipped may be conveyed by the conveyor 171 and packed by the packing machine 172, and the packed box may be conveyed by the conveyor 171 and eventually shipped (delivered).

The stop area 174 may be an area in the movement area 150 (for example, an area which is adjacent to the packing area 102 and which is constituted of one or more sections 201 of the movement area 150) or an area outside of the movement area 150 (for example, inside the packing area 102).

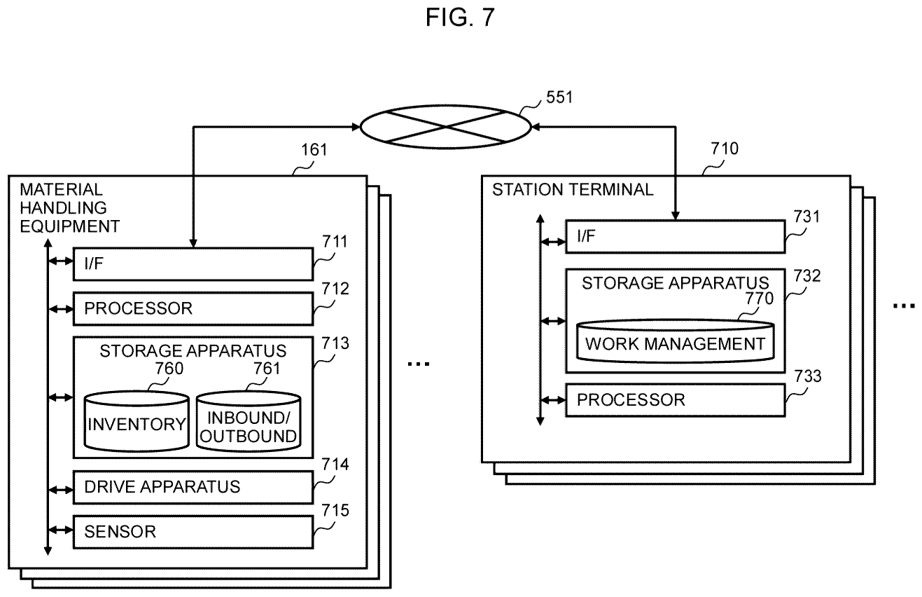

FIGS. 6 and 7 are diagrams showing a specific configuration example of elements of a carry system according to the present embodiment.

The carry system includes the control apparatus 4, the carry apparatus 3, material handling equipment 161, a station terminal 710, and a network 551 (for example, a wireless communication line such as a wireless LAN (Local Area Network)). Each constituent element of the carry system may be provided alone or in plurality. Each of the carry apparatus 3, the control apparatus 4, the material handling equipment 161, and the station terminal 710 can communicate via the network 551. The carry system may be referred to as a “logistics system”.

The carry apparatus 3 includes a drive apparatus 11, a storage apparatus 12, an interface apparatus 13, a plurality of types of sensors 14, a battery, and a controller 10 coupled thereto.

The controller 10 is a controller that controls the operation of the carry apparatus 3 in accordance with a movement instruction from the control apparatus 4, a state of charge of the built-in battery, or the like. The drive apparatus 11 includes drive wheels 20, auxiliary wheels 21, and an actuator (not illustrated) such as a motor to rotate and drive the drive wheels 20.

The interface apparatus 13 is an apparatus for communicating with the control apparatus 4 using a predetermined wireless communication scheme and may be constituted of, for example, a wireless LAN card.

The sensors 14 are devices for collecting information on a floor surface on which the carry apparatus 3 travels and various kinds of information related to the carry apparatus 3. For example, the sensors 14 are capable of reading information on markers on a section 201 of the floor surface. As the plurality of types of sensors 14, the carry apparatus 3 may include a camera for imaging a condition of the section 201, a vibration sensor for detecting vibrations received by the carry apparatus 3 during movement, a speed sensor for measuring the speed of the carry apparatus 3, an acceleration sensor for measuring the acceleration of the carry apparatus 3, a weight sensor to measure the weight of a load (articles to be conveyed), a gyro sensor to measure an orientation of the carry apparatus 3.

For example, the storage apparatus 12 stores a route table 23, an apparatus table 24, a map table 25, a measurement table 27, and a record table 28. The controller 10 stores a communication program 29, a movement control program 30, a measurement program 31, and a position estimation program 32. A communication unit, a travel control unit, a measuring unit, and a position estimating unit are realized as the controller 10 executes the communication program 29, the movement control program 30, the measurement program 31, and the position estimation program 32.

The route table 23 is a table which stores the above-mentioned movement instructions received from the control apparatus 4 and information representing a movement route specified in the movement instructions (the information representing the movement route may include information on a section of the movement route and the like). The apparatus table 24 is a table which stores an ID, a present position (section), and a state (for example, “standby”, “moving”, or “conveying”) of each carry apparatus 3. The map table 25 is a table which stores information representing a position and an attribute of each section (for example, which region the section belongs to). Note that the map table 25 may include information such as that illustrated in FIG. 2. The measurement table 27 is a table which stores values measured by the plurality of types of sensors 14 (for example, speed, acceleration, rotation, weight, position (value read from marker), and a photographed image of the section). The record table 28 is a table which stores information representing movement records including routes along which each carry apparatus 3 had moved and a date and time of movement.

The communication program 29 is a program including a function of exchanging commands and information with the control apparatus 4 via the interface apparatus 13. For example, the communication program 29 transmits at least a part of the information in tables 23 to 25, 27, and 28 to the control apparatus 4 upon a request (or without a request) from the control apparatus 4. Note that the communication program 29 of each carry apparatus 3 may transmit each of these pieces of information to the control apparatus 4 at regular or irregular intervals.

The movement control program 30 is a program for controlling the movement of the carry apparatus 3 in accordance with a movement instruction received through the communication program 29 from the control apparatus 4. For example, the movement control program 30 controls the drive apparatus 11 so as to move along a designated movement route in accordance with a movement instruction from the control apparatus 4.

The measurement program 31 registers an output (measurement result) of each sensor 14 in the measurement table 27. The position estimation program 32 estimates the position of the carry apparatus 3 based on a marker (a marker in the section 201 of the movement area 150) detected through the sensors 14 of the carry apparatus 3.

The control apparatus 4 may be one or more physical computers with hardware such as a processor 40, a memory 41, a storage apparatus 42, an input apparatus 43, an output apparatus 44, and an interface apparatus 45 or a system (for example, a cloud computing system) realized on one or more physical computers (for example, a cloud infrastructure). In addition, each apparatus included in the control apparatus 4 may be arranged in one physical computer or arranged in a plurality of physical computers in a distributed manner. Each program or each piece of information included in the storage apparatus 42 may be stored in one storage apparatus or stored in a plurality of storage apparatuses in a distributed manner. Instead of the input apparatus 43 and the output apparatus 44, input and output of information may be enabled via a client system that enables communication through the interface apparatus 45.

The processor 40 is a device which controls operations of the control apparatus 4 as a whole. The memory 41 is used as a work memory of the processor 40. The storage apparatus 42 stores programs and tables. The input apparatus 43 is constituted of, for example, a mouse and a keyboard and is used to input information and instructions required by an operator to the control apparatus 4. The output apparatus 44 may be a display apparatus such as a liquid crystal display or an organic EL (Electro Luminescence) display. The interface apparatus 45 is an apparatus for communicating with the carry apparatus 3, the material handling equipment 161, and the station terminal 710 using a predetermined wireless communication scheme and may be constituted of, for example, a wireless LAN card.

For example, the storage apparatus 42 stores a carry apparatus table 53, an inventory table 54, an order table 55, a map table 56, a storage area table 57, a work management table 58 (picking work management table 581 and loading work management table 582), a shipping box table 59, and a movement area table 60. The map table 56 is information (for example, a table storing a position (coordinates) and attribute of each section) representing a map of the movement area 150 (and each stop area) (this table 56 may be distributed to each carry apparatus 3 and saved as the map table 25 in each carry apparatus 3). Note that the map table 56 may include information such as that illustrated in FIG. 2.

The storage apparatus 42 stores an integrated WCS program 51 and a plurality of WCS programs 50. Integrated WCS and WCS are realized as the processor 40 executes the integrated WCS program 51 and the WCS programs 50. WCS stands for Warehouse Control System. The integrated WCS program 51 controls the carry apparatus 3 and the material handling equipment 161 in an integrated manner. The WCS programs 50 control the material handling equipment 161 or the carry apparatus 3. For example, a first WCS program 50 controls the material handling equipment 161 (specifically, the automated warehouse 161B) of the automated warehouse area 101B. A second WCS program 50 controls the shelf carry area (specifically, the carry apparatus 161C). A third WCS program 50 controls the carry apparatus 3.

The material handling equipment 161 is equipment which is provided in the storage area 101 (typically, a storage area to which GTP is applied) and which is used for inbound movement, storage, outbound movement, or the like of the storage area 101. For example, the material handling equipment 161 is the automated warehouse 161B in the automated warehouse area 101B or the carry apparatus 161C in the shelf carry area 101C. For example, the material handling equipment 161 includes an interface apparatus 711, a storage apparatus 713, a drive apparatus 714, a sensor 715, and a processor 712 coupled thereto.

The interface apparatus 711 is an apparatus for communicating with the control apparatus 4 using a predetermined wireless communication scheme and may be constituted of, for example, a wireless LAN card. The drive apparatus 714 is an apparatus that drives the material handling equipment 161. The sensor 715 may be a sensor that detects a position or the like of the material handling equipment 161.

The storage apparatus 713 stores an inventory table 760 and an inbound/outbound movement table 761. The inventory table 760 may be a table including the same information as at least a part of the inventory table 54 included in the control apparatus 4. The inbound/outbound movement table 761 may be a table including information regarding inbound movement or outbound movement of articles. By executing a program in the storage apparatus 713, the processor 712 controls operations of the material handling equipment 161 as a whole based on, for example, the inventory table 760 and the inbound/outbound movement table 761.

The station terminal 710 is an information processing terminal which is provided in a WS (work station (in other words, the work area 163)) and which displays a work management table 770 that is an example of information related to a work (for example, picking work or loading work) of a worker and accepts input from the worker upon work completion. A work state of object work is update by the input of work completion. For example, the station terminal 710 includes an interface apparatus 731, a storage apparatus 713, and a processor 733 coupled thereto. Note that a WS may be referred to as a work station or a working station.

The interface apparatus 731 is an apparatus for communicating with the control apparatus 4 using a predetermined wireless communication scheme and may be constituted of, for example, a wireless LAN card. The storage apparatus 732 stores the work management table 770. The work management table 770 may be a table including information corresponding to the WS among the work management table 58 included in the control apparatus 4. By executing a program in the storage apparatus 732, the processor 733 controls operations of the station terminal 710 as a whole based on, for example, the work management table 770. The station terminal 710 may include an input apparatus and an output apparatus. The input apparatus may accept input of information related to work by the worker such as completion of work. The output apparatus may output an instruction or the like related to work to the worker.

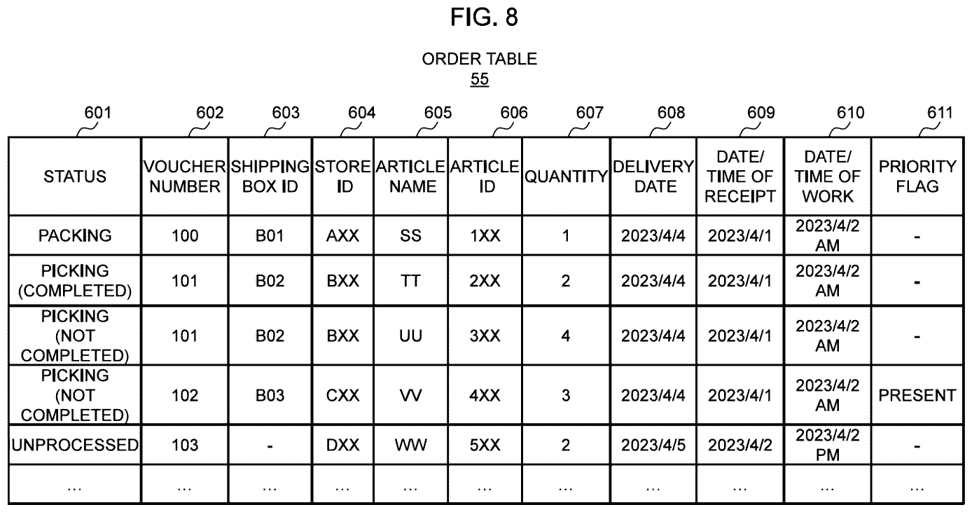

FIG. 8 is a diagram showing a configuration example of the order table 55.

The order table 55 is a table that stores various kinds of information related to an order from a customer. The order table 55 has a record for each article. Each record holds information such as a status 601, a voucher number 602, a shipping box ID 603, a store ID 604, an article name 605, an article ID 606, a quantity 607, a delivery date 608, date/time of receipt 609, date/time of work 610, and a priority flag 611. Let us take one article as an example (an “article of interest” in the description of FIG. 8). According to the example shown in FIG. 8, if the voucher number 602 is the same, articles may be handled as one order even if types of the articles (for example, the article name 605 and the article ID 606) are different.

The status 601 represents a work status related to the article of interest. The voucher number 602 represents a number of an order (number of a voucher) that designates the article of interest.

The shipping box ID 603 represents an ID of the shipping box 87 allocated to the article of interest. The store ID 604 represents an ID of a store of a distributor or a manufacturer of the article.

The article name 605 represents a name of the article of interest, the article ID 606 represents an ID of the article of interest, and the quantity 607 represents the quantity of the article of interest (the quantity of ordered articles of interest).

The delivery date 608 represents a deadline by which the article of interest is delivered to a delivery destination (typically, a customer). The date/time of receipt 609 represents a date and time at which the order designating the article of interest had been received. The date/time of work 610 represents a date and time at which specific work (for example, picking work, loading work, inspection work, packing work, or the like) related to the article of interest is performed. Information on a work deadline or a shipping deadline may be provided in addition to or in place of the pieces of information described above.

The priority flag 611 is a flag attached to an order (a voucher number or a shipping box group) to be prioritized such as a sudden order or when a work deadline is approaching. An order with priority flag 611 of “present” is an order with a higher priority than an order without the priority flag 611. Note that the priority flag 611 may represent priority of multiple levels such as “high”, “normal”, and “low”.

The priority flag 611 may be automatically attached when the time until a work deadline is equal to or less than a predetermined time, when the order is designated an urgent order, or the like or may be attached by an input by a manager and/or a worker. In addition, when an order is divided into a plurality of shipping boxes and the status 601 of a part of the shipping boxes is “picking completed” but the status 601 of the remaining shipping boxes is “picking not completed”, the priority flag 611 may attached for the purpose of increasing efficiency including preventing stagnation of articles related to the order such as attaching the priority flag 611 to the remaining shipping boxes.

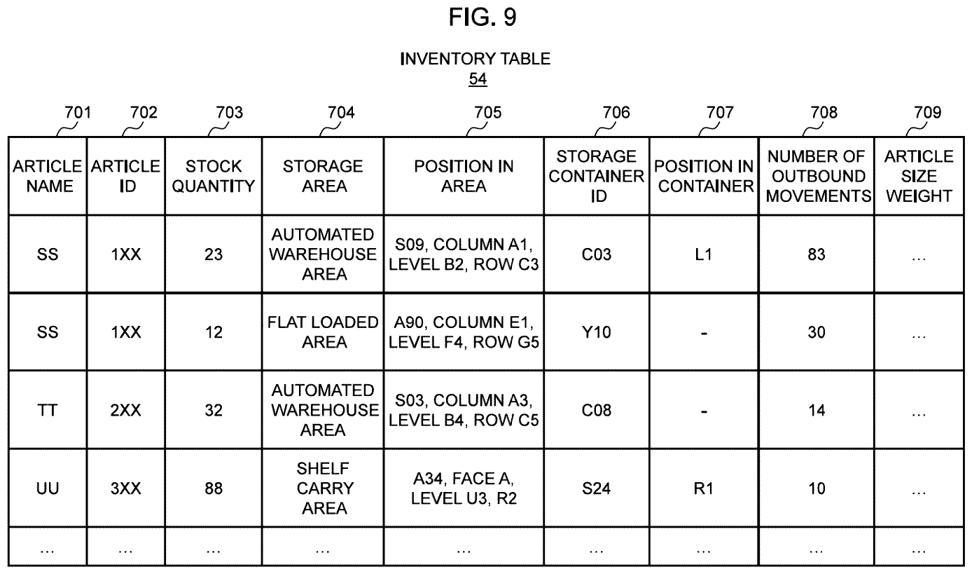

FIG. 9 is a diagram showing a configuration example of the inventory table 54.

The inventory table 54 is a table that stores information related to articles. The inventory table 54 has a record for each set including an article and the storage area 101. The inventory table 54 may have a record for each set including an article and a position-in-area 705 of the storage area 101. Each record holds information such as an article name 701, an article ID 702, a stock quantity 703, a storage area 704, the position-in-area 705, a storage container ID 706, a position-in-container 707, the number of outbound movements 708, and an article size weight 709. Let us take one article as an example (an “article of interest” in the description of FIG. 9).

The article name 701 represents a name of the article of interest. The article ID 702 represents an ID of the article of interest. The stock quantity 703 represents a quantity of the article of interest in stock. The storage area 704 represents an ID of the storage area 101 in which the article of interest is arranged. The position-in-area 705 represents a position of the article of interest in the storage area 101. The storage container ID 706 represents an ID of the storage container at the position represented by the position-in-area 705. The position-in-container 707 represents a position of the article of interest in the storage container. The number of outbound movements 708 represents the number of outbound movements of the article. The article size weight 709 represents a size or a weight of the article.

A configuration of the pieces of information 705 to 707 differ depending on the storage area 101. For example, when the storage area 101 is the automated warehouse area 101B, the position-in-area 705 is constituted of a value representing an ID of the automated warehouse area 101B and a position (column, level, and row) in the automated warehouse, the storage container ID 706 is constituted of a value representing an ID of a bucket that is a storage container used in the automated warehouse area 101B, and the position-in-area 707 is constituted of a value representing a frontage in the bucket. When the storage area 101 is the flat-loaded area 101A, the position-in-area 705 is constituted of a value representing an ID of the flat-loaded area 101A and a position (for example, column, level, and row (or column and row)) in the flat-loaded area 101A. When the storage area 101 is the shelf carry area 101C, the position-in-area 705 is constituted of a value representing an ID (or an address) of a storage section of a mobile shelf, a face of the mobile shelf, a level of the mobile shelf, and a frontage of the mobile shelf, the storage container ID 706 is constituted of a value representing an ID of the mobile shelf, and the position-in-container 707 is constituted of a value representing a position in the frontage of the mobile shelf. When the storage area 101 is the movable shelf area 101D, the position-in-area 705 is constituted of a value representing an ID of a movable shelf and the position-in-container 707 is constituted of a value representing a position in the movable shelf.

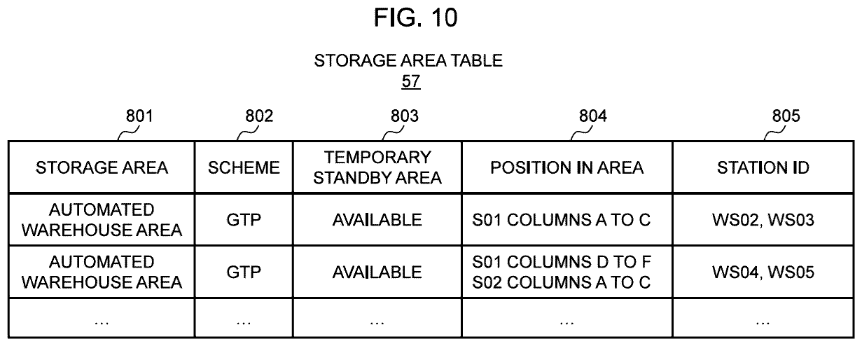

FIG. 10 is a diagram showing a configuration example of the storage area table 57.

The storage area table 57 is a table that stores information related to the storage areas 101. The storage area table 57 has a record for each position-in-area. Each record holds information such as a storage area 801, a scheme 802, a temporary standby area 803, a position-in-area 804, and a station ID 805. Let us take one position-in-area as an example (a “position-in-area of interest” in the description of FIG. 10).

The storage area 801 represents a type of the storage area 101 that includes the position-in-area of interest. The scheme 802 represents a scheme of outbound movement or picking.

The temporary standby area 803 represents a presence or absence of a temporary standby area. The presence or absence of a temporary standby area may be managed for each storage area 101 or for each WS (or WS group (two or more WSs)). While an area may be secured for each WS as the temporary standby area, a plurality of WSs may share a temporary standby area.

The position-in-area 804 represents a position-in-area of interest. The station ID 805 represents an ID of a WS (a WS to which an outbound movement can be performed) that corresponds to the position-in-area.

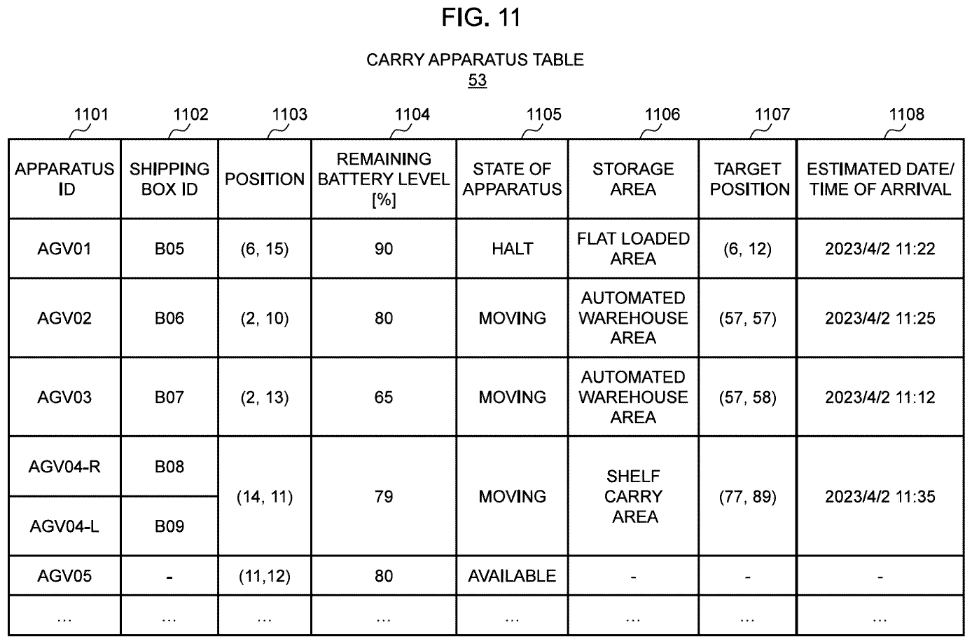

FIG. 11 is a diagram showing a configuration example of the carry apparatus table 53.

The carry apparatus table 53 is a table that stores information related to each carry apparatus 3. The carry apparatus table 53 has a record for each carry apparatus 3. Each record holds information such as an apparatus ID 1101, a shipping box ID 1102, a position 1103, a remaining battery level 1104, a state of apparatus 1105, a storage area 1106, a target position 1107, and an estimated date/time of arrival 1108. Let us take one carry apparatus 3 as an example (a “carry apparatus 3 of interest” in the description of FIG. 11).

The apparatus ID 1101 represents an ID of the carry apparatus 3 of interest. The shipping box ID 1102 represents an ID of the shipping box 87 to be loaded onto the carry apparatus 3 of interest. When a plurality of shipping boxes 87 are to be loaded on the carry apparatus 3 of interest, a plurality of IDs are recorded as the ID of the carry apparatus 3 of interest. For example, in the example shown in FIG. 11, a record with “AGV04-R” and “AGV04-L” as the apparatus ID 1101 represents that a shipping box with a shipping box ID of “B08” is loaded on a right side (R) relative to the front of an apparatus with the apparatus ID of “AGV04” and a shipping box with a shipping box ID of “B09” is loaded on a left side (L) relative to the front of the apparatus with the apparatus ID of “AGV04”.

The position 1103 represents coordinates of the section (in other words, a present section) at which the carry apparatus 3 of interest is positioned. The remaining battery level 1104 represents a remaining level of the battery of the carry apparatus 3 of interest.

The apparatus state 1105 represents a state of the carry apparatus 3 of interest. “Moving” means that the carry apparatus 3 of interest is moving. “Available” means that a shipping box has not been allocated to the carry apparatus 3 of interest. “Parked” means that the carry apparatus 3 of interest is parked in the stop area (or the temporary standby area).

The storage area 1106 represents a storage area at a movement destination of the carry apparatus 3 of interest. The target position 1107 represents the movement destination of the carry apparatus 3 of interest and may be a location related to the storage area 1106 or a location in a vicinity of the storage area 1106. For example, a stop area or a temporary standby area before a WS (work area) of the storage area 1106 may suffice.

The estimated date/time of arrival 1108 is an estimated date/time at which the carry apparatus 3 of interest arrives at the movement destination. For example, the estimated date/time of arrival 1108 may be a date and time calculated by the integrated WCS program 51 (or the WCS programs 50) based on a movement route to the movement destination of the carry apparatus 3 of interest.

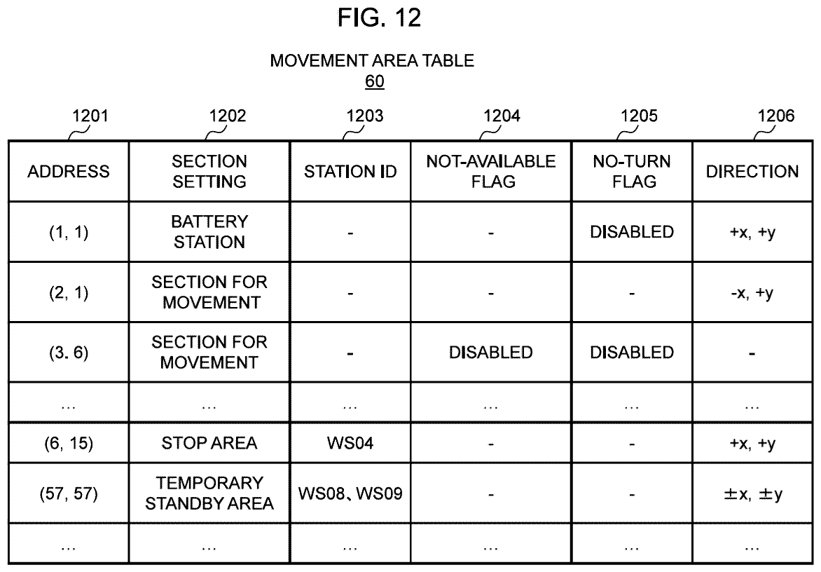

FIG. 12 is a diagram showing a configuration example of the movement area table 60.

The movement area table 60 holds information for each section in the movement area 150. The movement area table 60 has a record for each section. Each record holds information such as an address 1201, a section setting 1202, a station ID 1203, a not-available flag 1204, a no-turn flag 1205, and a direction 1206. Let us take one section as an example (a “section of interest” in the description of FIG. 12).

The address 1201 represents an address (position information) of the section of interest. The section setting 1202 represents what kind of section the section of interest is set up as. For example, a “section for movement” is a section in which the carry apparatus 3 travels. A “stop area” is a section belonging to a stop area. A “temporary standby area” is a section belonging to a temporary standby area. The station ID 1203 represents an ID of a WS corresponding to the section of interest.

The not-available flag 1204 is a flag representing whether or not the section of interest is not available (cannot become a constituent element of a movement route). The no-turn flag 1205 represents whether or not the section of interest enables the carry apparatus 3 to turn. The direction 1206 represents a direction in which the carry apparatus 3 present in the section of interest can move.

Note that when a carry apparatus such as an AGV travels in the storage area 101, a table similar to the movement area table 60 may be managed with respect to the storage area 101. In this case, mainly, the WCS program 50 that controls the carry apparatus may refer to or update the table.

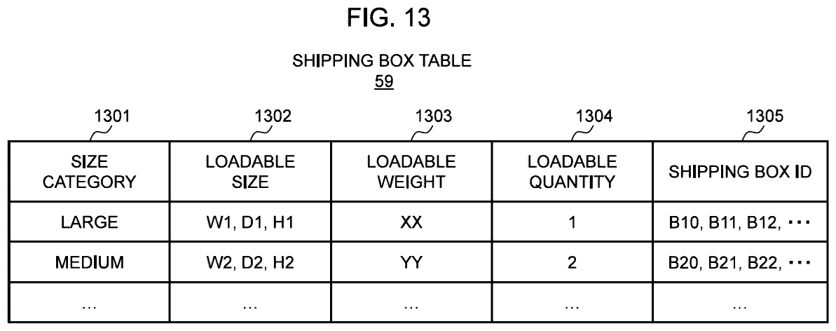

FIG. 13 is a diagram showing a configuration example of the shipping box table 59.

The shipping box table 59 is a table that stores information related to each shipping box. The shipping box table 59 has a record for each size category of shipping boxes. Each record stores information such as a size category 1301, a loadable size 1302, a loadable weight 1303, a loadable quantity 1304, and a shipping box ID 1305. Let us take one shipping box as an example (a “shipping box of interest” in the description of FIG. 13).

The size category 1301 represents a size category (for example, large, medium, or small) which the shipping box of interest belongs to. The loadable size 1302 represents a size (for example, a width, a depth, and a height) of a size of articles loadable in the shipping box of interest. The loadable weight 1303 represents a weight of articles loadable in the shipping box of interest.

The loadable quantity 1304 represents a maximum quantity of shipping boxes belonging to a same size category as the size category of the shipping box of interest that can be loaded to the carry apparatus 3.

The shipping box ID 1305 represents an ID of the shipping box of interest. Specifically, for each size category, the shipping box ID 1305 is a list of IDs of shipping boxes of interest that belong to the size category. Note that while the IDs included in the shipping box ID 1305 may cover all shipping boxes, the IDs included in the shipping box ID 1305 may only cover the IDs of shipping boxes that have not been allocated to a voucher number (in other words, empty shipping boxes) (in other words, when an ID of a shipping box to be allocated is selected from the shipping box ID 1305, the ID may be deleted from the shipping box ID 1305).

In addition, with respect to the shipping box table 59, a record may be provided for each shipping box and an allocation situation (a status of unallocated or already allocated, an already-allocated voucher number, an ID of an already-allocated carry apparatus 3, and the like may be managed) in addition to the pieces of information 1301 to 1305 described above.

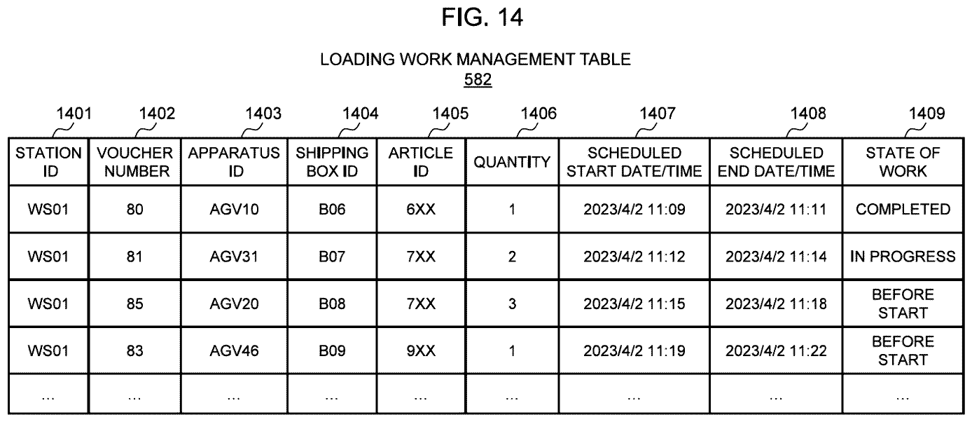

FIG. 14 is a diagram showing a configuration example of the loading work management table 582.

The loading work management table 582 is a table related to loading work. The loading work management table 582 has a record for each performance of loading work. Each record holds information such as a station ID 1401, a voucher number 1402, an apparatus ID 1403, a shipping box ID 1404, an article ID 1405, a quantity 1406, a scheduled start date/time 1407, a scheduled end date/time 1408, and a state of work 1409. Let us take one performance of loading work as an example (“loading work of interest” in the description of FIG. 14).

The station ID 1401 represents an ID of a WS in which the loading work of interest is performed. The voucher number 1402 represents a voucher number of an order corresponding to the loading work of interest. The apparatus ID 1403 represents an ID of the carry apparatus 3 that conveys the shipping box 87 in which article is to be placed (loaded) in the loading work of interest to a WS.

The shipping box ID 1404 represents an ID of the shipping box in which the article is to be placed (loaded) in the loading work of interest, the article ID 1405 represents an ID of the article, and the quantity 1406 represents the number of articles to be loaded in the loading work of interest.

The scheduled start date/time 1407 represents a scheduled start date/time of the loading work of interest. The scheduled end date/time 1408 represents a scheduled end date/time of the loading work of interest. The scheduled start date/time 1407 may be calculated by the integrated WCS program 51 or the WCS programs 50 based on a scheduled date/time of arrival of the carry apparatus 3 along a movement route at the WS or a predicted time length required by loading work that is performed before the loading work of interest (or a scheduled end date/time) of the loading work that is performed before the loading work of interest. The scheduled end date/time 1408 may be calculated by the integrated WCS program 51 or the WCS programs 50 based on the scheduled start date/time 1407 and a predicted time length required by the loading work of interest. The predicted time length required by loading work may be calculated by the integrated WCS program 51 or the WCS programs 50 based on at least one of a quantity of articles to be objects of loading work, an average required time of loading work, and a past record of loading work by workers of loading work. Note that loading work may be performed by a robot in place of or in addition to a worker.

The state of work 1409 represents a state of the loading work of interest. “Before start” means that the loading work of interest is yet to be started. “In progress” means that the loading work of interest has been started but is not yet completed. “Completed” means that the loading work of interest has been completed. Note that a change to the state of work 1409 may be performed based on an input from a worker of the loading work of interest or performed automatically based on an automatically-detected value related to the loading work of interest.

Note that the loading work management table 582 may manage a record for each WS by creating a table for each WS or the like so that the state of loading work of each WS can be comprehended and an order of the records may be an order of arrivals of the carry apparatus 3 (shipping box 87) at each WS.

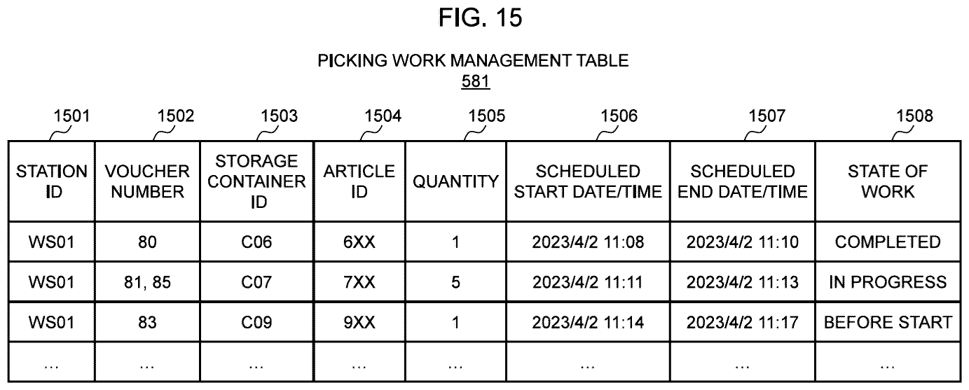

FIG. 15 is a diagram showing a configuration example of the picking work management table 581.

The picking work management table 581 is a table related to picking work. The picking work management table 581 has a record for each execution of picking work. Each record holds information such as a station ID 1501, a voucher number 1502, a storage container ID 1503, an article ID 1504, a quantity 1505, a scheduled start date/time 1506, a scheduled end date/time 1507, and a state of work 1508. Let us take one performance of picking work as an example (“picking work of interest” in the description of FIG. 15).

The station ID 1501 represents an ID of a WS in which the picking work of interest is performed. The voucher number 1502 represents a voucher number of an order corresponding to the picking work of interest. The storage container ID 1503 represents an ID of the storage container including an article to be picked in the picking work of interest.

The article ID 1504 represents an ID of the article to be picked in the picking work of interest, and the quantity 1505 represents a quantity of the article to be picked.

The scheduled start date/time 1506 represents a scheduled start date/time of the picking work of interest. The scheduled end date/time 1507 represents a scheduled end date/time of the picking work of interest. The scheduled start date/time 1506 may be calculated by the integrated WCS program 51 or the WCS programs 50 based on a scheduled date/time of arrival of the storage container at the WS or a predicted time length required by picking work that is performed before the picking work of interest (or a scheduled end date/time of the picking work that is performed before the picking work of interest). The scheduled end date/time 1507 may be calculated by the integrated WCS program 51 or the WCS programs 50 based on the scheduled start date/time 1506 and a predicted time length required by the picking work. The predicted time length required by picking work may be calculated by the integrated WCS program 51 or the WCS programs 50 based on at least one of a quantity of articles to be objects of picking work, an average required time of picking work, and a past record of picking work by workers of picking work. Note that picking work may be performed by a robot in place of or in addition to a worker.

The state of work 1508 represents a state of the picking work of interest. “Before start” means that the picking work of interest is yet to be started. “In progress” means that the picking work of interest has been started but is not yet completed. “Completed” means that the picking work of interest has been completed. Note that a change to the state of work 1508 may be performed based on an input from a worker of the picking work of interest or performed automatically based on an automatically-detected value related to the picking work of interest.

Note that the picking work management table 581 may manage a record for each WS by creating a table for each WS or the like so that the state of picking work of each WS can be comprehended and an order of the records may be an order of arrivals of the articles (storage containers) at each WS.

In addition, although there is a voucher number 1502 representing a plurality of different voucher numbers (for example, “81” and “85”), this is related to the loading work management table 582 (for example, the record including the voucher numbers 1402 “81” and “85”) and represents that articles of orders with different voucher numbers are to be picked together in one performance of picking work.

Hereinafter, an example of processing performed in the present embodiment will be described. Note that in the present embodiment, based on information (for example, information containing measured values of sensors) that is periodically or irregularly received by the control apparatus 4 from each carry apparatus 3, each material handling facility 161, and each station terminal 710, the integrated WCS program 51 or the WCS programs 50 update the relevant portion of tables 53 to 60 as appropriate.

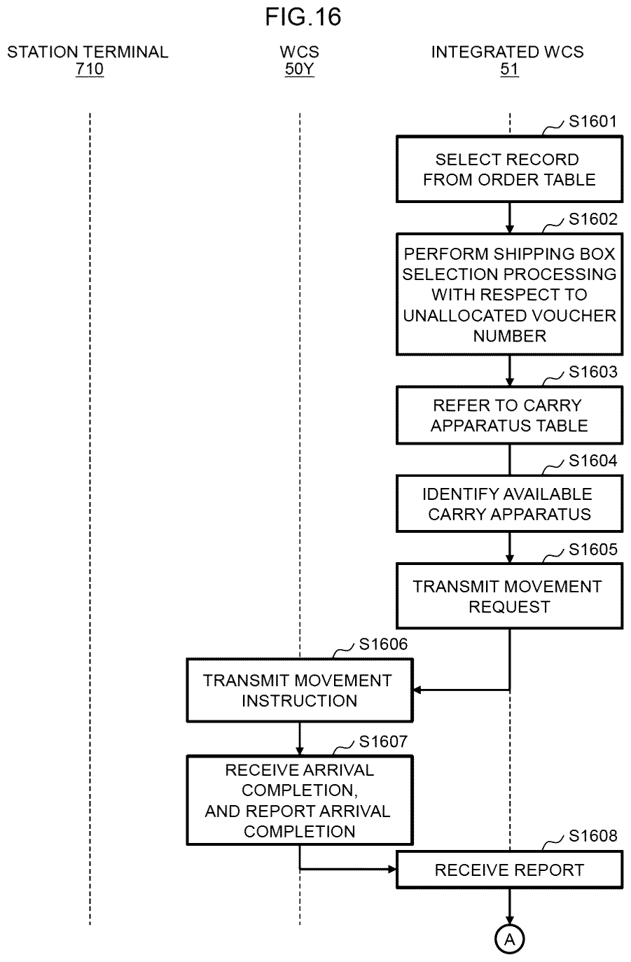

FIGS. 16 to 21 are flow charts showing a flow of order processing. Note that in the following description, a “WCS program 50X” refers to the WCS program 50 corresponding to the material handling equipment 161 of the storage area 101 that is a movement destination. A “WCS program 50Y” refers to the WCS program 50 that corresponds to the carry apparatus 3.

As shown in FIG. 16, in S1601, the integrated WCS program 51 selects one or more records in which the date/time of work 610 is a predetermined date/time of work from the order table 55. Note that an order with the priority flag 611 of “present” may be preferentially processed as compared to an order without a priority flag in at least a part of processing in the following order processing with respect to the order (for example, including a priority in an order of outbound movement of articles from the material handling equipment 161 in the storage area 101 and a priority in an order of arrival and/or an order of stand-by at the stop area 164 of the carry apparatus 3).

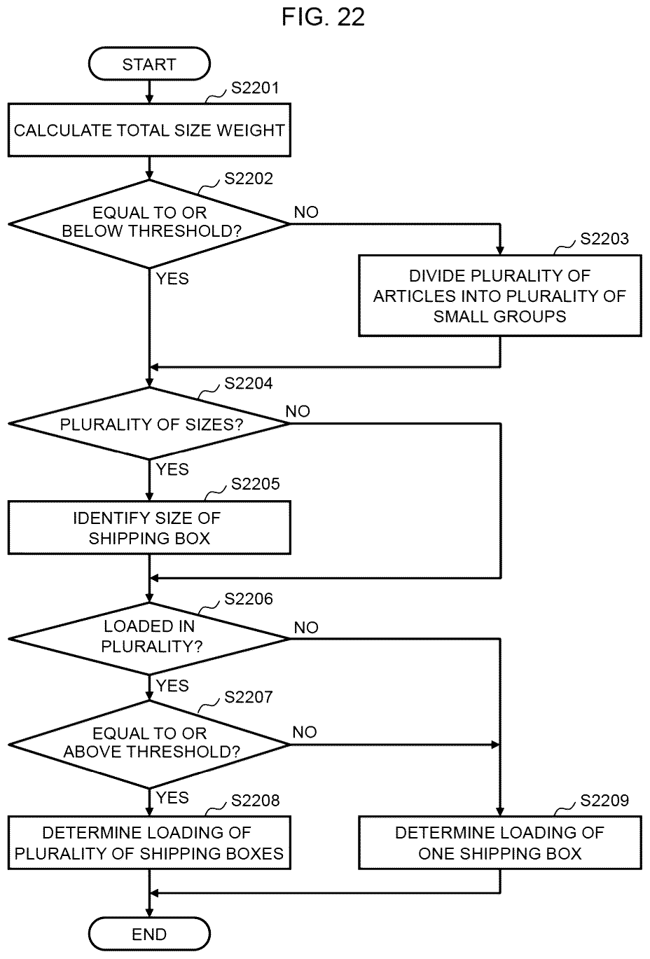

In S1602, the integrated WCS program 51 refers to the order table 55, specifies a voucher number to which the shipping box ID 603 has not been allocated, and performs shipping box selection processing (FIG. 22). At this point, for example, when all of the articles corresponding to the specified voucher number does not fit into one shipping box, a determination is made as to divide the articles into a plurality of shipping boxes. In addition, when the shipping boxes come in a plurality of sizes, the size of the shipping box is specified and a determination is made as to whether a plurality of shipping boxes can be loaded to one carry apparatus 3 (when a plurality of shipping boxes are to be loaded, the number of shipping boxes to be loaded is determined). By performing S1602, information related to shipping boxes in each of all records identified in S1601 (for example, a part of or all information corresponding to each record such as a shipping box group ID, sizes of shipping boxes, the number of shipping boxes to be loaded on the carry apparatus 3, a combination of shipping box groups, shipping box IDs, and the like) is set (determined) and recorded in the order table 55.

In S1603, the integrated WCS program 51 refers to the carry apparatus table 53.

In S1604, the integrated WCS program 51 specifies the carry apparatus 3 to which a shipping box is unallocated (the state of apparatus 1105 is “available”).

In S1605, the integrated WCS program 51 transmits a movement request to move the specified carry apparatus 3 to a supply WS (WS of the shipping box supply area 100) to the WCS program 50Y. An apparatus ID of the carry apparatus specified in S1604 and a destination area (for example, a stop area of a movement destination) are designated in the movement request.

In S1606, in accordance with the movement request, the WCS program 50Y transmits a movement instruction of a movement to the supply WS to the designated carry apparatus 3.

In S1607, the WCS program 50Y receives a notification from the carry apparatus 3 of the completion of arrival at the supply WS and reports to the integrated WCS that the carry apparatus 3 has arrived at the supply WS.

In S1608, the integrated WCS program 51 receives a report of completion of arrival.

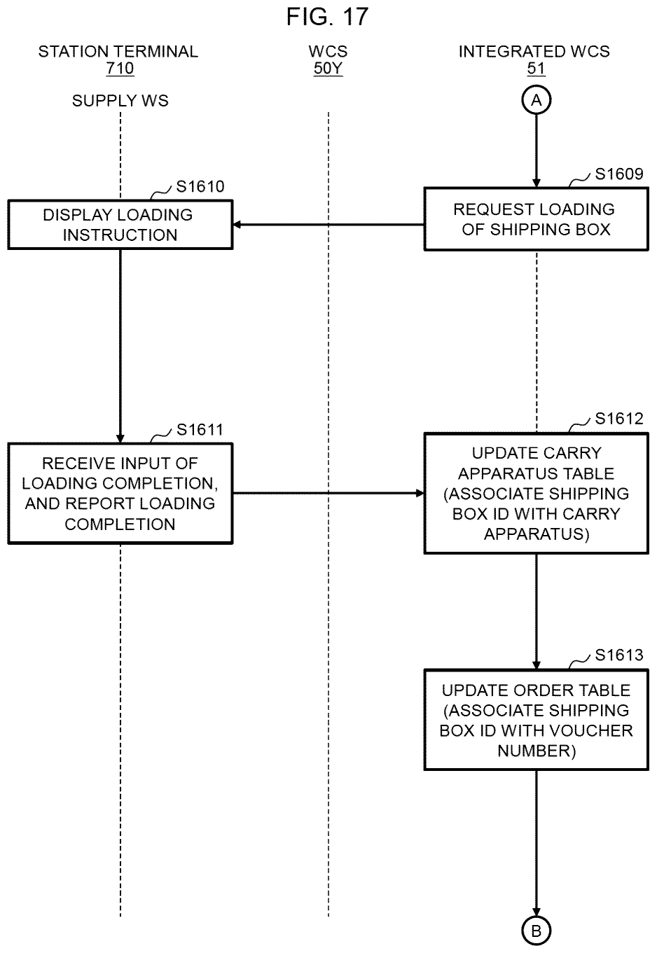

As shown in FIG. 17, in S1609, the integrated WCS program 51 transmits a loading request of the shipping box to the station terminal 710 of the supply WS. For example, the loading request includes information related to shipping boxes specified in S1602 (for example, a part of or all information such as a shipping box group ID, sizes of shipping boxes, the number of shipping boxes to be loaded on the carry apparatus 3, a combination of shipping box groups, shipping box IDs, and the like).

In S1610, the station terminal 710 of the supply WS displays the loading instruction of the shipping boxes based on the loading request. The loading instruction to be displayed is information related to the shipping boxes to be loaded to the carry apparatus 3 having arrived at the stop area corresponding to the supply WS and includes information included in the loading request. Loading work is performed in accordance with the displayed loading instruction. For example, at the supply WS, with respect to shipping boxes of the “sizes of shipping boxes” and the “the number of shipping boxes” designated in the loading instruction, information on IDs of the shipping boxes to be loaded may be inputted to the station terminal 710 by having a worker or a work robot scan (read) a code (for example, including a shipping box ID) attached to the shipping boxes to be loaded. The worker or the work robot loads the shipping boxes with codes that have been scanned to the carry apparatus 3 in the WS. When there are a plurality of sizes of the shipping boxes, the display of the loading instruction includes information on the sizes of the shipping boxes. The worker loads the shipping boxes of the sizes (in other words, in accordance with the loading instruction, one or a plurality of shipping boxes are loaded to one carry apparatus 3).

Note that as a modification, the supply WS may be divided into each size of the shipping boxes and, in this case, the integrated WCS program 51 may transmit a movement request to the WCS program 50Y so as to move the carry apparatus 3 to the supply WS in accordance with the size of the shipping boxes. As another modification, where there is a carry apparatus 3 corresponding to the state of apparatus 1105 of “available”, a shipping box may be loaded at the supply WS in advance and an unallocated voucher number (shipping box group) may be subsequently allocated to the shipping box.

In S1611, the station terminal 710 receives an input of loading completion from the worker and reports loading completion (for example, including information on a shipping box ID) to the integrated WCS program 51.

In S1612, the integrated WCS program 51 receives the report of loading completion and updates the carry apparatus table 53 (with respect to the object carry apparatus 3, sets the ID of the loaded shipping box as the shipping box ID 1102).

In S1613, the integrated WCS program 51 updates the order table 55. For example, the integrated WCS program 51 allocates the loaded shipping box to an object voucher number (shipping box group). When a plurality of shipping boxes are loaded to the same carry apparatus, the integrated WCS program 51 allocates each loaded shipping box to each shipping box group corresponding to an object combination of shipping box groups. In the order table 55, the integrated WCS program 51 sets the ID of the loaded (allocated) shipping box as the shipping box ID 603 to the record of each article corresponding to each shipping box group.

Note that as a modification, when a shipping box ID is set in S1602 (FIG. 22) and information on the shipping box ID is included in the loading request of S1609 and the loading instruction of S1610, a worker or a work robot may load a shipping box with the shipping box ID designated in the loading instruction to the carry apparatus 3.

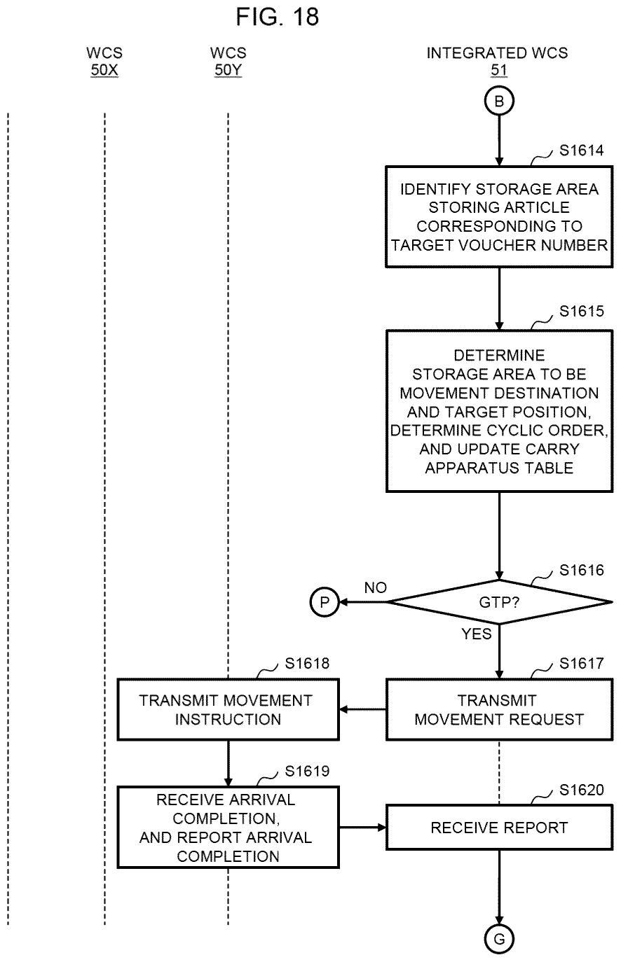

As shown in FIG. 18, in S1614, the integrated WCS program 51 refers to the order table 55 and the inventory table 54 and specifies the storage area 101 storing the article corresponding to the object voucher number (an article whose the status 601 represents that picking or loading is not completed).

In S1615, the integrated WCS program 51 refers to the work management table 58 (picking work management table 581 and loading work management table 582), the storage area table 57, the movement area table 60, and the carry apparatus table 53 (furthermore, for example, refers to the inbound/outbound movement table 761 of each material handling equipment 161). From the referred tables, the integrated WCS program 51 specifies a work state (for example, work capacity and congestion) of each WS, a position and a movement state (for example, a movement destination and an estimated date/time of arrival) of each carry apparatus 3, articles scheduled to be moved outbound, and the like and determines (selects) a storage area to be a movement destination and a target position (for example, a WS or a temporary standby area of the movement destination storage area 101). Based on the determination, the integrated WCS program 51 determines an order of travel (all of or a part of movement destinations including at least the first movement destination). The integrated WCS program 51 updates the carry apparatus table 53 (for example, the state of apparatus 1105, the storage area 1106, and the target position 1107).

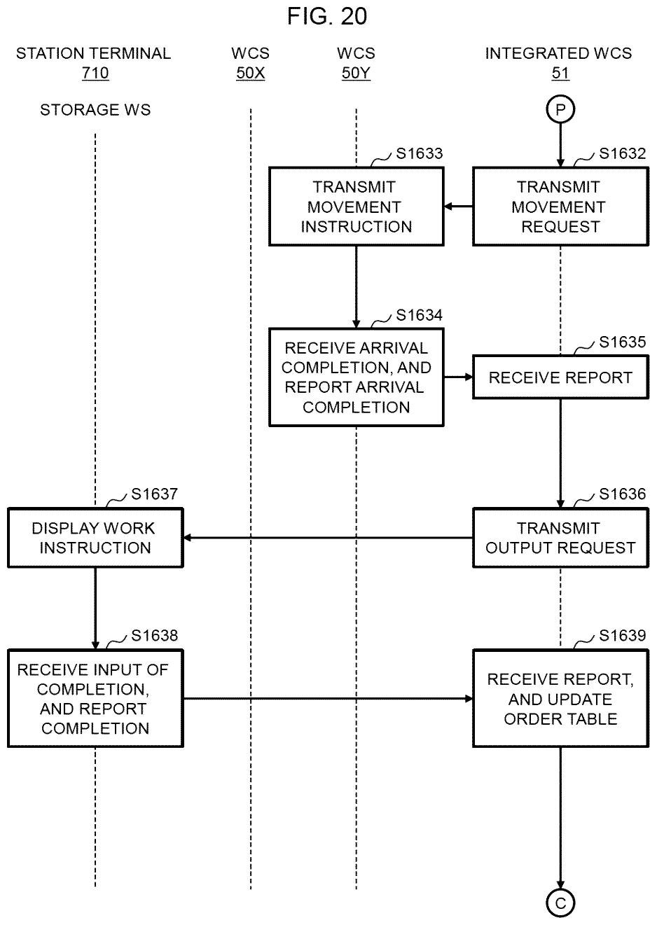

In S1616, the integrated WCS program 51 refers to the storage area table 57 and determines whether or not the storage area 101 that is the movement destination is a GTP area (an area to which GTP is applied). When the determination result of S1616 is false (S1616: NO), processing advances to S1632 (FIG. 20).

When the determination result of S1616 is true (S1616: YES), in S1617, the integrated WCS program 51 transmits a movement request to move the carry apparatus 3 to the target position to the WCS program 50Y.

In S1618, in accordance with the movement request, the WCS program 50Y transmits a movement instruction to move the carry apparatus 3 to the target position to the carry apparatus 3.

In S1619, the WCS program 50Y receives a notification of completion of arrival at the target position from the carry apparatus 3 and reports to the integrated WCS program 51 that arrival has been completed.

In S1620, the integrated WCS program 51 receives a report of completion of arrival.

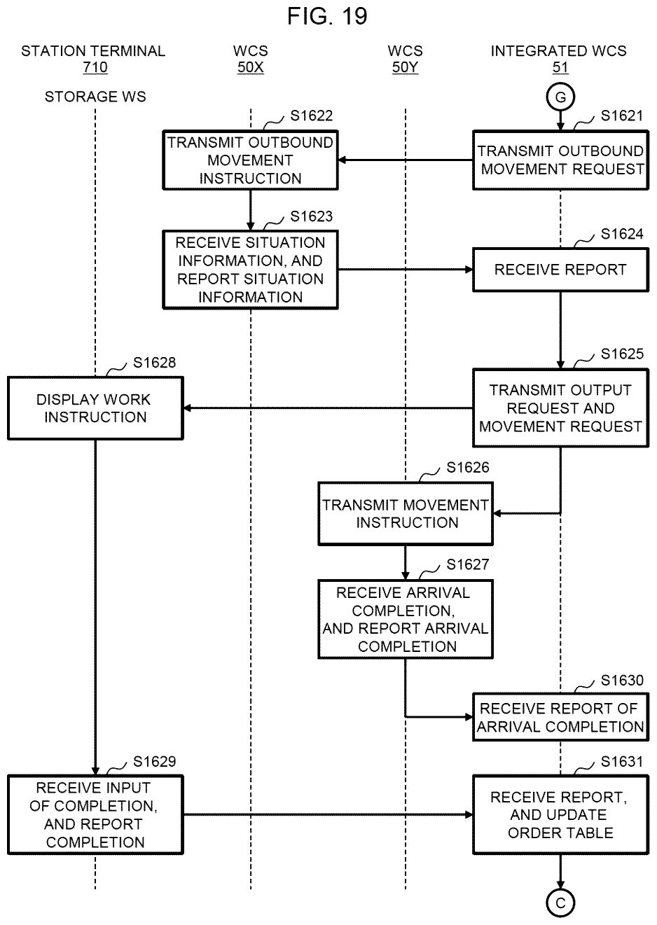

As shown in FIG. 19, in S1621, the integrated WCS program 51 transmits an outbound movement request to move out an article (article corresponding to an object voucher number) from the movement destination storage area 101 to the WCS program 50X corresponding to the material handling equipment 161 of the movement destination storage area 101.

In S1622, in accordance with the outbound movement request, the WCS program 50X transmits an outbound movement instruction to move out the article corresponding to the object voucher number to the corresponding material handling equipment 161. Note that the outbound movement instruction may include a part of or all of information representing an outbound movement destination WS in the storage area 101 or an order and timings of arrival of the articles.

For example, the WCS program 50X refers to the inventory table 54 and specifies the position-in-area 705 corresponding to the article name 701 and/or the article ID 702 of the article that is an outbound movement object. The WCS program 50X refers to the storage area table 57 and specifies the position-in-area 804 corresponding to the position-in-area 705, specifies the station ID 805 corresponding to the position-in-area 804, and specifies (determines) a WS to be an outbound movement destination (outbound movement destination WS, carry destination WS).

When there are a plurality of station IDs, the WCS program 50X may refer to the picking work management table 581 and determine the WS to be an outbound movement destination of articles in consideration of the state of the picking work task of each WS so that the work task of each WS is leveled or optimized (based on work processing speed of the worker or the like). In addition, when it is more efficient to collectively perform picking with another picking work task (picking work task with respect to same or different article such as an article corresponding to another voucher number), the WCS program 50X may determine the outbound movement destination WS so that the WS to become the outbound movement destination is the same WS or determine an order of arrival and/or timings of arrival of articles at the outbound movement destination WS so as to enable collective picking.

In S1623, the WCS program 50X receives state information representing an outbound movement state or a carry state of articles from the material handling equipment 161 and reports state information to integrated WCS. For example, the state information may include information representing an outbound movement destination WS in the storage area 101 or an order and timings of arrival of the articles.

In S1624, the integrated WCS program 51 receives a report including state information of an outbound movement state and a carry state.

In S1625, the integrated WCS program 51 transmits an output request (request to display work instruction of picking and loading) to the station terminal 710 of the storage WS (WS in movement destination storage area 101) and transmits a movement request to the WCS program 50Y. Specifically, for example, based on the state information (for example, information on the outbound movement destination WS or information on an order and timings of arrival of the articles), the integrated WCS program 51 transmits an output request to the station terminal 710 of the storage WS or determines a movement request that causes an order or a timing of arrival of the carry apparatus 3 at the stop area 164 corresponding to the storage WS and an order or a timing of arrival of the articles at the outbound movement destination WS to be the same and transmits the movement request to the WCS program 50Y. The work instruction includes information representing an article to be picked in the movement destination storage area 101 and loaded to the carry apparatus 3, the number of articles, and an article position (position-in-area or position-in-container).

In S1626, in accordance with the movement request, the WCS program 50Y transmits a movement instruction to the target position of the carry apparatus 3 (WS in storage area 101) to the carry apparatus 3.

In S1627, the WCS program 50Y receives a notification of arrival at the target position from the carry apparatus 3 and reports to the integrated WCS program 51 that arrival has been completed.

In S1628, the station terminal 710 of the storage WS displays a work instruction of picking and/or loading based on the output request.

In S1629, the station terminal 710 receives an input of picking completion and/or loading completion from the worker and reports work completion to the integrated WCS program 51.

In S1630, the integrated WCS program 51 receives a report of completion of arrival.

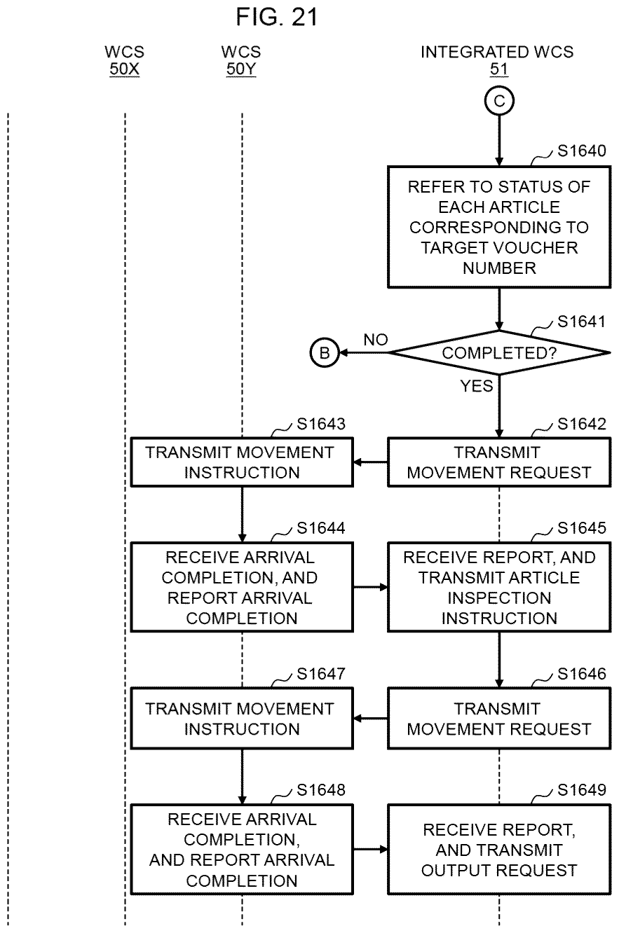

In step S1631, the integrated WCS program 51 receives the report of picking completion and/or loading completion and updates the status 601 of the order table 55 (updates the status 601 of the article corresponding to the object voucher number to picking and/or loading “completed”). Once the status 601 changes to the status of picking and loading “completed”, processing advances to S1640 (FIG. 21).

When S1616: NO in FIG. 18, as described above, the processing advances to S1632 in FIG. 20. In S1632, the integrated WCS program 51 transmits a movement request to move the carry apparatus 3 to a target position (storage WS) of the movement destination storage area 101 to the WCS program 50Y.

In 51633, in accordance with the movement request, the WCS program 50Y transmits a movement instruction to the target position of the carry apparatus 3 to the carry apparatus 3.

In 51634, the WCS program 50Y receives a notification of arrival at the target position from the carry apparatus 3 and reports to the integrated WCS program 51 that arrival has been completed.

In 51635, the integrated WCS program 51 receives a report of completion of arrival.

In 51636, the integrated WCS program 51 transmits an output request that is a request to display a work instruction of picking and/or loading to the station terminal 710 of the storage WS. The work instruction includes information representing an article to be picked in the movement destination storage area 101 and loaded to the carry apparatus 3, the number of articles, and an article position (position-in-area or position-in-container).

In S1637, the station terminal 710 displays a work instruction of picking and loading based on the output request.

In S1638, the station terminal 710 receives an input of picking completion and/or loading completion from the worker and reports work completion to the integrated WCS program 51.

In step S1639, the integrated WCS program 51 receives the report of work completion and updates the status 601 of the order table 55 (updates the status 601 of the article corresponding to the object voucher number to picking and/or loading “completed”). Once the status 601 changes to the status of picking and loading “completed”, processing advances to S1640 (FIG. 21).

As shown in FIG. 21, in S1640, the integrated WCS program 51 refers to the status 601 of each article corresponding to the object voucher number (and/or object shipping box ID) in the order table 55.

In S1641, the integrated WCS program 51 determines whether or not the status 601 of each article corresponding to the object voucher number (or the object shipping box ID or IDs of a plurality of shipping boxes to be loaded on the same carry apparatus 3) is “completed” (in other words, whether all articles corresponding to the object voucher number are already loaded to the shipping box). When the determination result of S1641 is false (S1641: NO), processing returns to S1614 in FIG. 18. In other words, another movement destination storage area is specified and similar processing proceeds.

When the determination result of S1641 is true (S1641: YES), in S1642, the integrated WCS program 51 transmits a movement request to move the carry apparatus 3 to the target position in the article inspection area 103 to the WCS program 50Y.

In S1643, in accordance with the movement request, the WCS program 50Y transmits a movement instruction to move the carry apparatus 3 to the target position (article inspection area 103) to the carry apparatus 3.

In S1644, the WCS program 50Y receives a notification of completion of arrival at the target position from the carry apparatus 3 and reports to the integrated WCS program 51 that arrival has been completed.

In S1645, the integrated WCS program 51 receives a report of completion of arrival and transmits an article inspection instruction to an article inspection apparatus (not illustrated) in the article inspection area 103.

In S1646, the integrated WCS program 51 receives a report of article inspection completion and transmits a movement request to move the carry apparatus 3 to a target position of the packing area 102 to the WCS program 50Y.

In S1647, in accordance with the movement request, the WCS program 50Y transmits a movement instruction to move the carry apparatus 3 to the target position (packing area 102) to the carry apparatus 3.

In S1648, the WCS program 50Y receives a notification of completion of arrival at the target position from the carry apparatus 3 and reports to the integrated WCS program 51 that arrival has been completed.

In S1649, the integrated WCS program 51 receives a report of arrival completion and transmits an output request of a loading instruction to transfer a shipping box to the packing area 102 to the station terminal 710 of a WS in the packing area 102. The integrated WCS program 51 updates the state of apparatus 1105 of the carry apparatus 3 from which a shipping box has been removed to “available” and transmits a movement request to move the carry apparatus 3 to a next target position (for example, the standby area 105 or the shipping box supply area 100) to the WCS program 50Y.

FIG. 22 is a flow chart showing a flow of shipping box selection processing.

In S2201, the integrated WCS program 51 calculates a total size weight (a sum of sizes and/or weights) corresponding to an object voucher number (a voucher number to which a shipping box is unallocated). Specifically, for example, the integrated WCS program 51 specifies the article name 605, the article ID 606, and the quantity 607 corresponding to the object voucher number from the order table 55. For each set of the article name 605 and the article ID 606, the integrated WCS program 51 specifies the article size weight 709 corresponding to the set from the inventory table 54 and calculates a product of the specified article size weight 709 and the quantity 607 corresponding to the set. The integrated WCS program 51 calculates the total size weight corresponding to the object voucher number by adding up all calculated products.

In S2202, the integrated WCS program 51 determines whether or not the total size weight calculated in S2201 is equal to or less than a predetermined threshold.

When the determination result of S2202 is false (S2202: NO), in S2203, the integrated WCS program 51 divides the plurality of articles corresponding to the object voucher number into a plurality of small groups so that the total size weight becomes equal to or less than the predetermined threshold. The “small group” corresponds to a unit of shipping boxes. In other words, S2202: NO means that it has been determined that the plurality of articles corresponding to the object voucher number does not fit into one shipping box and, in this case, the integrated WCS program 51 makes a determination to divide the plurality of articles into a plurality of shipping boxes. Note that when at least one article exceeds the threshold of the total size weight, the integrated WCS program 51 may notify the manager of an error (or a manual picking request).

In this case, a group (unit) of a plurality of articles allocated to one shipping box may be referred to as a “shipping box group (order container group)”. For example, when the plurality of articles corresponding to the object voucher number are divided into a plurality of “small groups” such as when the determination result of S2202 is false (S2202: NO), each “small group” becomes a “shipping box group”. In addition, for example, when all of the articles corresponding to the object voucher number can be placed in the same shipping box such as when the determination result of S2202 is true (S2202: YES), all of the articles corresponding to the object voucher number becomes a same “shipping box group”. The integrated WCS program 51 attaches a shipping box group ID that is unique identification information to each “shipping box group”.

After S2203 or when the determination result of S2202 is true (S2202: YES), in S2204, the integrated WCS program 51 refers to the shipping box table 59 (for example, the column of size category 1301) and determines whether or not there are a plurality of sizes of shipping boxes.

When the determination result of S2204 is true (S2204: YES), in S2205, the integrated WCS program 51 refers to the shipping box table 59 or the inventory table 54 and specifies a size of a shipping box capable of accommodating the total size weight of the object shipping box group based on the loadable size 1302 and/or the loadable weight 1303 and the article size weight 709 of each article.

After S2205 or when the determination result of S2204 is false (S2204: NO), in S2206, the integrated WCS program 51 refers to the shipping box table 59 and determines whether or not the size of the shipping box is a size that enables the plurality of shipping boxes to be loaded onto the carry apparatus 3. Specifically, the integrated WCS program 51 determines whether or not a value of the loadable quantity 1304 corresponding to the size category 1301 of the shipping box is “2” or more.

When the determination result of S2206 is true (S2206: YES), in S2207, the integrated WCS program 51 determines whether or not a time until a work deadline (or a shipping deadline) is equal to or longer than a threshold. Note that information on the work deadline (and/or the shipping deadline) corresponding to each order may be included in, for example, the order table 55.

When the determination result of S2207 is true (S2207: YES), in S2208, the integrated WCS program 51 makes a determination to load the plurality of shipping boxes onto the carry apparatus 3 and determines the number of shipping boxes to be loaded onto the carry apparatus 3 (for example, the loadable quantity 1304 corresponding to the size category 1301 of the shipping boxes).

In addition, when loading a plurality of shipping boxes onto the carry apparatus 3, the integrated WCS program 51 selects “another unallocated shipping box group” to be allocated to another shipping box to be loaded together on the same carry apparatus 3 as the shipping box to which the “object shipping box group” is allocated. For example, the integrated WCS program 51 also performs the shipping box selection processing shown in FIG. 22 with respect to another unallocated voucher number, specifies the size of the shipping box to be allocated to “another unallocated shipping box group”, and selects “another unallocated shipping box group” that matches the other shipping box size.

In addition, when loading a plurality of shipping boxes onto one carry apparatus 3, the integrated WCS program 51 selects (determines) a combination of shipping box groups to be allocated to the plurality of shipping boxes in order to improve efficiency of picking work, loading work, and/or carry. For example, when the integrated WCS program 51 refers to the order table 55 and finds another unallocated shipping box group with the same voucher number as the object shipping box group, the integrated WCS program 51 may select the other unallocated shipping box group. Since articles of the same voucher number can be conveyed to the article inspection area 103 or the packing area 102 at a timing where the articles are gathered in each shipping box, efficiency of carry, article inspection, and packing can be improved.

For example, the integrated WCS program 51 may refer to the order table 55 and select “another unallocated shipping box group” including articles with a high overlap rate (overlap degree) of articles such as when there is an article or there are many articles that is/are the same as the article corresponding to the object shipping box group. Collectively picking the same articles and loading the articles to each shipping box to be conveyed by the same carry apparatus 3 enables efficiency of picking work, loading work, and/or carry to be improved. In addition, for example, the integrated WCS program 51 may refer to the order table 55, the inventory table 54, and the storage area table 57 and select “another unallocated shipping box group” including articles with a high overlap rate (overlap degree) of storage areas (or carry destination WSs to which an outbound movement can be performed) such as when there is an article or there are many articles whose storage areas (or carry destination WSs to which an outbound movement can be performed) are the same as the article corresponding to the object shipping box group. Accordingly, in addition to improving movement efficiency of the carry apparatus 3, a waiting time for arrival of the carry apparatus 3 at the carry destination WS can be reduced and, further, stagnation of picked articles at the WS can be reduced, thereby improving the efficiency of picking work and loading work. Note that in addition to or instead of the selection criteria described above, since a carry time (including waiting time) of the carry apparatus 3 increases when the number of destinations in the storage area (carry destination WS) increases, the integrated WCS program 51 may refer to the order table 55, the inventory table 54, the storage area table 57, and the like and select “another unallocated shipping box group” based on other selection criteria such as ensuring that the work is completed in time for the work deadline (calculating a scheduled work completion date/time and ensuring that the time from the scheduled work completion date/time to the work deadline is equal to or longer than a predetermined threshold), ensuring that a charge rate of the carry apparatus 3 does not equal to or fall below a threshold (calculating a carry time and ensuring that the carry time falls within a predetermined range), ensuring that the number of destinations in the storage area (carry destination WS) equals to or falls below a predetermined threshold. The integrated WCS program 51 may select “another unallocated shipping box group” so that efficiency of processing with respect to not only the object shipping box group but also all voucher numbers included in the date/time of work is improved (optimized).

In S1609 and S1610, the integrated WCS program 51 exercises control (requests loading of shipping boxes and issues a loading instructions) so that a shipping box to which the object shipping box group is to be allocated and a shipping box to which the selected “another unallocated shipping box group” is to be allocated are loaded onto the same carry apparatus 3. Note that a combination of an object shipping box group and the selected shipping box group may be referred to as a “combination of shipping box groups”.

In correspondence to the object shipping box group, the integrated WCS program 51 may record, in the order table 55, information related to shipping boxes (for example, a shipping box group ID, sizes of shipping boxes, the number of shipping boxes to be loaded on the carry apparatus 3, a combination of shipping box groups, and the like).

When the determination result of S2206 is false (S2206: NO) or when the determination result of S2207 is false (S2207: NO), in S2209, the integrated WCS program 51 makes a determination to load one shipping box onto the carry apparatus 3. Specifically, for example, in correspondence to the object shipping box group, the integrated WCS program 51 may record, in the order table 55, information related to shipping boxes (for example, a shipping box group ID, sizes of shipping boxes, the number of shipping boxes to be loaded on the carry apparatus 3, and the like).

As an example, when setting shipping box IDs in the shipping box selection processing of FIG. 22, after S2208 and S2209, the integrated WCS program 51 may refer to the shipping box table 59, set the IDs of unallocated shipping boxes which correspond to the size specified in S2205 and the number specified in S2208 or S2209 (the number of shipping boxes to be loaded onto the carry apparatus 3) as the shipping box ID 603 corresponding to the object shipping box group, and record the same in the order table 55.

In the processing illustrated in FIG. 22, at least S2207 may be optional. For example, when loading a plurality of shipping boxes corresponding to a plurality of voucher numbers onto one carry apparatus 3, it takes time to gather the articles in all of the plurality of shipping boxes. Therefore, when time is prioritized in relation to a work deadline such as when a work deadline of the object voucher number is approaching, the integrated WCS program 51 may make a determination to load only one shipping box. However, even when a plurality of shipping boxes are loaded onto the carry apparatus 3, articles may be gathered while prioritizing any of the shipping boxes and the shipping box may be subjected to article inspection and packing first. Subsequently, in order to gather the articles corresponding to the remaining shipping boxes which have not been packed, the carry apparatus 3 may sequentially move to one or more storage areas 101 from the packing area 102.

While an embodiment has been described above, it should be noted that the description is simply an example to illustrate the present invention and is not intended to limit the scope of the invention only to the embodiment. The present invention can be implemented in various other modes.

In addition, for example, the shape of the sections is not limited to a square and may be another shape. In addition, there may be a mixture of sections with different sizes or shapes. Furthermore, instead of specifying a position of a section from a marker on the section, the position may be specified by another method.

In addition, for example, the integrated WCS program 51 and the WCS programs 50 may be executed by the carry apparatus 3 instead of or in addition to the control apparatus 4. In addition, the carry apparatus 3 may double as the control apparatus 4.

The above description can be summarized, for example, as follows. The following summary may include supplemental descriptions of the description provided above and descriptions of modifications of the embodiment described above.

The control apparatus 4 includes the interface apparatus 45, the storage apparatus 42, and the processor 40 coupled to the interface apparatus 45 and the storage apparatus 42. A logistics facility (such as a warehouse or a logistics center) includes a plurality of storage areas 101 that differ in at least one of a storage scheme, an outbound movement scheme, and a picking scheme. Each of the plurality of storage areas 101 includes one or more work stations (WSs) and one or more stop areas 164. Each of the one or more WSs is an area that may become an outbound movement destination of articles from the storage area 101 to which the WS is associated and an area (work area 163) where work (picking work) of picking the moved articles and/or placing the picked articles into an order container is performed.

Here, with respect to “placing the picked articles into an order container”, other expressions may be used such as “loading (storing, transferring, or the like) the picked articles into an order container”. In a similar manner, with respect to “the picked articles being placed into an order container”, other expressions may be used such as “the picked articles being loaded (stored, transferred, or the like) onto an order container”. In addition, with respect to work for “placing the picked articles into an order container”, other expressions may be used such as loading work, storing work, transferring work, or the like.

Each of the one or more stop areas 164 is an area where the carry apparatuses 3 stop. One or more storage areas 101 among the plurality of storage areas 101 includes the material handling equipment 161. The interface apparatus 45 communicates with the material handling equipment 161 of the one or more storage areas 101 and a plurality of carry apparatuses 3 including a first carry apparatus on which a first shipping box (an example of the first order container) corresponding to a first order (a first voucher number or a first shipping box group) is loaded. The storage apparatus 42 stores the inventory table 54 (an example of inventory information) including information about the inventory of articles arranged in each of the plurality of storage areas 101.

The integrated WCS program 51 and the plurality of WCS programs 50 executed by the processor 40 may be distributed to a plurality of physical or virtual computers. The integrated WCS program 51 may include each WCS program 50. The processor 40 may allocate the first order to the first shipping box and the first shipping box corresponding to the first order to the first carry apparatus. For example, in a case of a carry system in which only one shipping box is loaded onto the carry apparatus 3, the processor 40 may allocate the first order to the first carry apparatus. The shipping box is an example of the order container. A container other than a box may be adopted as the order container.

When the processor 40 specifies from the inventory table 54 that a plurality of articles corresponding to the first order is arranged (stored) in two or more storage areas 101 among the plurality of storage areas 101, the processor 40 selects a first storage area 101 (for example, the automated warehouse area 101B) in which a part of the articles corresponding to the first order is arranged among the two or more specified storage areas 101. The processor 40 may control the first carry apparatus 3 so as to move to the selected first storage area 101 (for example, a temporary standby area or a stop area corresponding to the first storage area 101) (for example, by having the integrated WCS program 51 transmit a movement request to the WCS program 50Y and the WCS program 50Y transmit a movement instruction to the first carry apparatus 3). The processor 40 controls the material handling equipment 161 (for example, the automated warehouse 161B) of the first storage area 101 so as to move out a part of the articles corresponding to the first order from the first storage area 101. The processor 40 refers to the storage area table 57 and specifies the carry destination WS (WS of first storage area, outbound movement destination WS) that is a WS to which a part of the articles are moved out. The processor controls the first carry apparatus 3 (the carry apparatus to which the first shipping box corresponding to the first order is loaded) so as to move to the stop area (for example, the stop area 164B) corresponding to the carry destination WS (for example, the work area 163B). After the part of articles having moved out are placed in the first shipping box loaded on the first carry apparatus 3 by a worker (and/or a work robot), the processor 40 controls the first carry apparatus 3 so as to move to a stop area (for example, the stop area 164A) corresponding to a second storage area 101 (for example, the flat-loaded area 101A) in which another part of the articles (unloaded) corresponding to the first order is arranged. Since articles of a same shipping unit (packing unit) are placed in the first shipping box corresponding to the first order, there is no need to sort the articles in the first shipping box. Accordingly, a workload of sorting work can be reduced even when storage positions of a plurality of articles corresponding to the first order straddle a plurality of storage areas 101 which differ in at least any of a storage scheme, an outbound movement scheme, and a picking scheme.

In addition, since the carry apparatus 3 that is a conveyor vehicle such as an AGV can be controlled so as to change the storage area or WS to be a movement destination, change the timing of movement, or change the order of arrival (order of standby) with other carry apparatuses 3 at the movement destination based on the status of each storage area 101 and each WS (standby state and congestion state of the carry apparatuses 3, state of work tasks of workers or work robots, and the like), the carry apparatus 3 is easier and more flexible than fixed conveyance equipment such as conveyors. Therefore, compared to fixed conveyance equipment such as conveyors, sudden orders can be more readily accommodated, work efficiency and movement efficiency can be improved by reducing standby time of workers and carry apparatuses 3, and there is more flexibility in a layout of multiple types of areas such as storage areas 101 and movement areas in logistics facilities (a layout can be more readily changed).

Note that when a plurality of articles corresponding to the first order is arranged in two or more storage areas 101, the processor 40 may control the material handling equipment 161 of the first storage area 101 so that a part of the articles corresponding to the first order is moved out from the first storage area 101, control the first carry apparatus 3 so as to move to the stop area 164 corresponding to the carry destination WS to which the part of articles has been moved, and control the first carry apparatus 3 so as to move to the second storage area 101 after the part of articles are placed in the first shipping box. In addition, the first storage area 101 may be an area to which GTP is applied and the second storage area 101 may be an area using another scheme to which GTP is applied or an area to which PTG is applied. Alternatively, the first storage area 101 may be an area to which PTG is applied and the second storage area 101 may be an area using another scheme to which PTG is applied or an area to which GTP is applied.

When the processor 40 (control apparatus 4) specifies from inventory information (inventory table 54) that a plurality of articles corresponding to the first order is arranged in two or more storage areas 101 among the plurality of storage areas 101, the processor 40 may control the first carry apparatus 3 so as to move to the stop area 164 (for example, the stop area 164A) corresponding to the second storage area 101 in which a part of the articles corresponding to the first order is arranged among the two or more specified storage areas 101. After the part of articles are placed in the first shipping box loaded on the first carry apparatus 3 by a worker (and/or a work robot), the processor 40 may determine the first storage area 101 (the stop area 164 corresponding to the first storage area 101) in which another part of the articles corresponding to the first order is arranged as the movement destination of the first carry apparatus 3. The processor 40 controls the material handling equipment 161 of the first storage area 101 so as to move out the other part of the articles corresponding to the first order from the first storage area 101. The processor 40 refers to the storage area table 57 and specifies the carry destination WS that is a WS to which the other part of the articles are moved out. The processor controls the first carry apparatus 3 to which the first shipping box corresponding to the first order is loaded so as to move to the stop area 164 corresponding to the carry destination WS. The other part of the articles having moved out is loaded by a worker (and/or a work robot) to the first shipping box to be loaded to the first carry apparatus 3.

When articles corresponding to each of two or more orders including the first order include articles arranged at the first storage area 101 (in other words, for example, when all of two or more articles corresponding to two or more orders in which the date/time of work 610 belongs to a same time slot are arranged in the first storage area 101), for example, in S1621 to S1624, the processor 40 may control the material handling equipment 161 of the first storage area 101 so as to move out the two or more articles corresponding to the two or more orders to the carry destination WS and may specify (determine) an order in which the two or more articles arrive at the carry destination WS. For example, in S1625 and S1626, the processor 40 may control two or more carry apparatuses 3 including the first carry apparatus 3 so that, with respect to each of two or more orders, an order of arrival (for example, an order of movement, an order of approach, or an order of standby) at the stop area 164 corresponding to the carry destination WS by the carry apparatus 3 on which a shipping box corresponding to the order is loaded matches the order in which the articles corresponding to the order arrive at the carry destination WS (the specified order described above). Accordingly, it is expected that work efficiency of work to pick articles that have been moved out and to load the articles into shipping boxes of the carry apparatus 3 can be improved and stagnation of the picked articles at the WS can be reduced.

For example, in S1621 to S1624, the processor 40 may specify (determine) a timing at which a part of articles corresponding to the first order are moved out and arrive at the carry destination WS or a timing at which the articles are picked at the carry destination WS. For example, in S1625 and S1626, the processor 40 may control the first carry apparatus 3 so that the first carry apparatus 3 on which the first shipping box corresponding to the first order is loaded arrives at the stop area 164 corresponding to the carry destination WS so as to coincide with the specified timing. Accordingly, it is expected that work efficiency of work to pick articles that have been moved out and to load the articles into shipping boxes of the carry apparatus 3 can be improved and stagnation of the picked articles at the WS can be reduced. Note that, for example, the “timing of arrival” of the articles at the carry destination WS may be a date and time predicted by a predetermined method and the “timing of picking” of the articles at the carry destination WS may be the scheduled start date/time 1506 or the scheduled end date/time 1507 corresponding to the articles and the carry destination WS.

When articles corresponding to each of two or more orders including the first order include articles arranged at the first storage area 101, for example, in S1625 and S1626, the processor 40 may specify (determine) an order in which the carry apparatuses 3 (two or more carry apparatuses 3) on which shipping boxes corresponding to each of the two or more orders are loaded arrive at the stop area 164 corresponding to the carry destination WS. In addition, in S1621 and S1622, with respect to each of the two or more orders, the processor 40 may control the material handling equipment (for example, the automated warehouse 161B or the carry apparatus 161C) of the first storage area 101 to move out the articles corresponding to the order to the carry destination WS so that an order in which the articles corresponding to the order arrive at the carry destination WS from the first storage area 101 matches the order in which the carry apparatuses 3 (two or more carry apparatuses 3) on which shipping boxes corresponding to the order are loaded arrive at the stop area 164 corresponding to the carry destination WS (the specified order described above). By controlling the order in which articles are moved out to the carry WS in this manner, it is expected that work efficiency of work to pick articles that have been moved out and to load the articles into shipping boxes of the carry apparatus 3 can be improved and stagnation of the picked articles at the WS can be reduced.

For example, in S1625 and S1626, the processor 40 may specify (determine) a timing at which the first carry apparatus 3 on which the first shipping box corresponding to the first order is loaded arrives at the stop area 164 corresponding to the carry destination WS. For example, in S1621 and S1622, the processor 40 may control the material handling equipment of the first storage area 101 so that a part of articles corresponding to the first order arrives at the carry destination WS so as to coincide with the specified timing. Accordingly, it is expected that work efficiency of work to pick articles that have been moved out and to load the articles into shipping boxes of the carry apparatus 3 can be improved and stagnation of the picked articles at the WS can be reduced. Note that, for example, the “timing at which the first carry apparatus 3 arrives at the stop area 164 corresponding to the carry destination WS” may be the corresponding “estimated date/time of arrival 1108”.

With respect to articles corresponding to a plurality of orders, the processor 40 may refer to the order table 55 and the inventory table 54 and specify the storage area 101 where the articles are stored (arranged) and refer to the storage area table 57 to specify a WS to which the articles can be moved out. With respect to articles corresponding to a first order and articles corresponding to a second order (for example, a second voucher number or a second shipping box group), the processor 40 may specify that articles which can be moved out to a same WS are at least partially included. With respect to a first shipping box and a second shipping box (an example of the second order container) loaded to the first carry apparatus 3, the processor 40 may allocate the first shipping box to the first order and the second shipping box to the second order. When articles that can be moved out to the same WS are arranged (stored) in the first storage area 101 and the WS to which the articles can be moved out is the carry destination WS, the processor 40 may control the material handling equipment of the first storage area 101 so that articles that can be moved out to the same WS are moved out to the carry destination WS from the first storage area 101 (for example, S1621 and S1622). With respect to articles that can be moved out to the same WS, the processor 40 can output picking information (work instruction information) including a quantity which corresponds to a plurality of orders including at least the first order and the second order and which is a quantity to be picked to the station terminal 710 of the carry destination WS of the first storage area (for example, S1625 and S1628). The processor 40 may control the first carry apparatus 3 to which the first shipping box and the second shipping box are loaded so as to move to the stop area 164 corresponding to the carry destination WS (for example, S1625 and S1626). With respect to articles that can be moved out to the same WS, the processor 40 can output loading information (work instruction information) including a quantity of the articles in the first order and which is a quantity to be placed in the first shipping box and loading information (work instruction information) including a quantity of the articles in the second order and which is a quantity to be placed in the second shipping box to the station terminal 710 of the carry destination WS of the first storage area (for example, S1625 and S1628). Accordingly, for example, in S1629, with respect to articles that can be moved out to the same WS in a plurality of orders (the first order and the second order), since the articles can be placed in each of a plurality of shipping boxes (first shipping box and second shipping box) to be loaded on a same carry apparatus (first carry apparatus 3), picking efficiency, loading efficiency, and movement efficiency can be improved.

With respect to each of one or two or more storage areas 101 at which articles not yet conveyed (articles not placed in the first shipping box corresponding to the first order) among a plurality of articles corresponding to the first order are arranged, the processor 40 may specify a state (for example, a state of congestion) at the storage area 101 or a state (for example, a work state) at a WS of the storage area 101. The processor 40 may determine a target position of a movement destination storage area 101 among the one or two or more storage areas 101 (a target position corresponding to the storage area 101 to become a movement destination) based on at least the specified state and control the first carry apparatus 3 so as to move to the determined target position. For example, in S1614 and S1615 in a case where S1641: NO, the processor 40 may specify a state and determine the movement destination storage area (target position) based on the specified state. Accordingly, it is expected that congestions at a specific storage area 101 or a specific WS can be suppressed and work tasks can be distributed, standby times of the carry apparatus 3 and the material handling equipment 161 can be reduced and, therefore, work efficiency and movement efficiency of the system as a whole can be improved.

With respect to a first article and a second article which are articles not placed in the first shipping box corresponding to the first order, the processor 40 may specify a state of a work task at each of a first WS where work for placing the first article in the first shipping box is performed and a second WS where work for placing the second article in the first shipping box is performed. The processor 40 may control the first carry apparatus 3 to move to the second WS whose work task is less than that of the first WS based on at least the specified states of the work task. In addition, the processor 40 may specify standby states of carry apparatuses corresponding to each of the first WS and the second WS and control the first carry apparatus 3 to move to the second WS at which the number of carry apparatuses on standby is smaller than that at the first WS based on at least the specified standby states of the carry apparatuses. Accordingly, it is expected that congestions at a specific storage area 101 or a specific WS can be suppressed and work tasks can be distributed, standby times of the carry apparatus 3 and the material handling equipment 161 can be reduced and, therefore, work efficiency and movement efficiency of the system as a whole can be improved.

When moving out a part of the articles corresponding to the first order from the first storage area 101, the processor 40 may specify a state of a work task at each of the first WS and the second WS that are WSs to which the part of the articles can be moved out. The processor 40 may determine the second WS whose work task is less than that of the first WS as the carry destination WS being a WS to which the part of articles is to be moved out based on at least the specified states of the work task. In addition, the processor 40 may specify standby states of carry apparatuses corresponding to each of the first WS and the second WS and determine the second WS at which the number of carry apparatuses on standby is smaller than that at the first WS based on at least the specified standby states of the carry apparatuses as the carry destination WS that is a WS to which the part of articles is to be moved out. The processor 40 may control the material handling equipment of the first storage area 101 so as to move out the articles to the carry destination WS. Accordingly, it is expected that congestions at a specific WS can be suppressed and work tasks can be distributed, standby times of the carry apparatus 3 can be reduced and, therefore, work efficiency and movement efficiency of the system as a whole can be improved.

For example, for each WS, the “state of a work task” at the WS may be an amount of a work task (which may include a work task with respect to articles to be moved out to the WS), the state of work 1508 of which is “in progress” or “before start” in the picking work management table 581. In addition, for each WS, the “state of a work task” at the WS may be an amount of a work task, the state of work 1409 of which is “in progress” or “before start” in the loading work management table 582. For example, when an amount of the work task of the first WS exceeds a predetermined threshold, the first WS may be excluded and the second WS may be determined as a movement destination of the first carry apparatus 3 or the carry destination WS. In addition, the second WS may be determined as the movement destination of the first carry apparatus 3 or the carry destination WS so that the amount of the work task of the first WS and the amount of the work task of the second WS are distributed (for example, by leveling).

In addition, for each WS, the “standby state of a carry apparatus” corresponding to the WS may be the number of carry apparatuses on standby with the apparatus ID 1403 which correspond to a work task, the state of work 1409 of which is “in progress” or “before start” in the loading work management table 582. In addition, the “standby state of a carry apparatus” corresponding to each WS may be, for example, an availability of the stop area 164 or the temporary standby area 165 (for example, the number of sections without carry apparatuses) corresponding to each WS which can be specified from the movement area table 60, the carry apparatus table 53, and the like. For example, when the number of carry apparatuses on standby exceeds a predetermined threshold as the “standby state of a carry apparatus” of the first WS or when the availability of the stop area 164 or the temporary standby area 165 corresponding to each WS is below a predetermined threshold, the first WS may be excluded and the second WS may be determined as a movement destination of the first carry apparatus 3 or the carry destination WS. In addition, the second WS may be determined as the movement destination of the first carry apparatus 3 or the carry destination WS so that the “standby states of a carry apparatus” of the first WS and the second WS are distributed (for example, by leveling).

When a plurality of shipping boxes are loaded on the carry apparatus 3 (for example, the first carry apparatus), articles corresponding to a plurality of shipping boxes (a plurality of orders) may be considered processing objects and, for example, a movement destination of the first carry apparatus 3, the carry destination WS, or the like may be determined. In addition, the first article and the second article are examples of a plurality of articles and there may be other articles. The first WS and the second WS are examples of a plurality of WSs and there may be other WSs.

When the first storage area 101 is provided with the temporary standby area 165 in addition to the stop area 164 (for example, in a case where the temporary standby area 803 in the storage area table 57 is “available” (the first storage area 101 or the temporary standby area 803 corresponding to the carry destination WS)), the processor 40 may control the first carry apparatus 3 so as to move to the temporary standby area 165 and control the material handling equipment 161 of the first storage area 101 so as to move out a part of the articles corresponding to an object order (for example, the first order) to the carry destination WS after the first carry apparatus 3 arrives at the temporary standby area 165 or after the first carry apparatus 3 starts moving toward the temporary standby area 165. The temporary standby area 165 can be used to suppress congestion such as carry apparatuses 3 gathering at a same timing at a specific WS in the movement destination storage area 101. The temporary standby area 65 is also useful when controlling an order or a timing of arrival by each carry apparatus 3 at the carry destination WS.

For example, with respect to S1615, at least one of the following may be adopted. The processor 40 may specify a state of work (a state of a work task (including a congestion state)) of each WS based on the loading work management table 582 (and/or the picking work management table 581). Based on the carry apparatus table 53, the processor 40 may specify a congestion state (which may include a future congestion schedule) from the position 1103, the storage area 1106, the target position 1107, and the estimated date/time of arrival 1108 corresponding to a carry apparatus 3 other than the first carry apparatus. The processor 40 may calculate the cost of traveling to each storage area 101 (for example, time and distance) and the expected date and time of arrival at each storage area 101 from the location of the first carry apparatus 3 (the processor 40 may determine a movement destination storage area and a target position (for example, a stop area corresponding to a WS in the storage area 101 or a temporary standby area corresponding to the WS) so that a specific WS does not become congested and is distributed at a same timing). Since it may be more efficient to pick the same articles for a plurality of shipping boxes (a plurality of voucher numbers) at once (however, it may not be efficient if the picked articles cannot be immediately loaded onto the carry apparatus 3 and remain in the WS), based on the picking work management table 581, the processor 40 may determine the movement destination storage area and the target position based on the articles scheduled to be moved out (scheduled to be picked) and the scheduled picking start (end) date and time.

The processor 40 may determine whether to load a plurality of shipping boxes or one shipping box onto the first carry apparatus 3 based on at least sizes of shipping boxes and the one determined shipping box or one (at least one) of the plurality of determined shipping boxes may be the first shipping box corresponding to the first order. By conveying a plurality of shipping boxes together, it is expected that work efficiency and movement efficiency can be improved.

The processor 40 may determine whether to load a plurality of shipping boxes or one shipping box onto the first carry apparatus 3 based on at least a work deadline of the first order. When a plurality of shipping boxes are conveyed together, it may take time to gather the articles in all of the shipping boxes and, therefore, the processor 40 may make a determination to load only one shipping box when there is not enough time to meet the work deadline for the order. Accordingly, since a plurality of shipping boxes can be conveyed together while meeting a work deadline or a shipping deadline, it is expected that work efficiency and movement efficiency can be improved.

The interface apparatus 45 may communicate with the station terminal 710 that is an information processing terminal provided in relation with a WS. The processor 40 may control the material handling equipment 161 of the first storage area 101 to move out a part of the articles to the carry destination WS of the first storage area 101 before the first carry apparatus 3 arrives at the stop area 164 corresponding to the carry destination WS. The processor 40 may instruct the station terminal of the carry destination WS of the first storage area 101 to pick the articles moved out to the carry destination WS. When the movement destination storage area 101 of the first carry apparatus 3 is the second storage area 101, the processor 40 may instruct the station terminal 710 of a WS of the second storage area 101 to pick the articles after the first carry apparatus 3 arrives at the stop area 164 corresponding to the WS of the second storage area 101. It is expected that performing control in accordance with the scheme of the storage area 101 enables standby times of the worker and the carry apparatus 3 to be reduced and efficiency to be improved. Note that instructing the station terminal 710 to pick (or load) articles may involve requesting the station terminal 710 to display instruction contents (transmitting an output request) or instructing a picking robot or a loading robot to perform picking or loading through the station terminal 710.

The storage apparatus 42 may store storage area information including information representing a scheme of outbound movement or picking for each storage area. For example, when the processor 40 specifies in S1616 from the storage area table 57 (example of storage area information) that the scheme corresponding to the movement destination storage area 101 is a scheme (for example, GTP) of picking articles moved out to the carry destination WS by the material handling equipment 161, the processor 40 may control the material handling equipment 161 so as to move out the articles to the carry destination WS of the movement destination storage area 101 before the carry apparatus 3 arrives at the stop area 164 corresponding to the carry destination WS of the movement destination storage area 101 and instruct the station terminal 710 of the carry destination WS of the movement destination storage area 101 to pick the articles having been moved out to the carry destination WS. For example, when the processor 40 specifies in S1616 from the storage area table 57 that the scheme corresponding to the movement destination storage area 101 is a scheme (for example, PTG) of having a worker pick articles from a storage position, the processor 40 may instruct the station terminal of a WS of the movement destination storage area 101 to pick the articles after the carry apparatus 3 arrives at the stop area 164 corresponding to the WS of the movement destination storage area 101. It is expected that performing control in accordance with the scheme of the storage area 101 enables standby times of the worker and the carry apparatus 3 to be reduced and efficiency to be improved.

With respect to the articles to be moved out from the first storage area 101, the processor 40 may output picking information (work instruction information) including the quantity of articles to be picked to the station terminal 710 of the carry destination WS of the first storage area 101. In addition, with respect to the articles having been moved out from the first storage area 101 and picked, the processor 40 may output, to the station terminal 710 of the carry destination WS of the first storage area 101, loading information (work instruction information) including the quantity of articles to be placed in the shipping box loaded onto the carry apparatus 3 having arrived at the stop area 164 corresponding to the carry destination WS. Accordingly, for example, in S1629, the worker can perform work correctly at the carry destination WS. Note that the picking information and the loading information may be one piece of work instruction information such as when only one of the two pieces of information is displayed or when they are displayed together. In addition, the picking information and the loading information may be displayed separately such as when a plurality of orders are picked together.

With respect to articles which correspond to a plurality of orders including a first order and a second order and which are to be moved out from the first storage area 101, the processor 40 can output picking information (work instruction information) including a quantity which corresponds to the plurality of orders including the first order and the second order and which is a quantity to be picked (a quantity of a plurality of orders to be picked together) to the station terminal 710 of the carry destination WS of the first storage area 101. With respect to the articles having been moved out from the first storage area 101 and picked, the processor 40 may output, to the station terminal 710 of the carry destination WS of the first storage area 101, loading information (work instruction information) including the quantity of articles to be placed in the first shipping box loaded onto the carry apparatus 3 having arrived at the stop area 164 corresponding to the carry destination WS and which is the quantity of articles in the first order corresponding to the first shipping box (for example, S1625 and S1628). The quantity of articles to be picked which is a quantity corresponding to a plurality of orders including the first order and the second order may be larger than the quantity of the articles in the first order corresponding to the first shipping box. Accordingly, for example, by picking articles together and loading into a plurality of shipping boxes in S1629, an improvement in picking efficiency is expected.

The plurality of carry apparatuses 3 may include the first carry apparatus 3 to which the first shipping box corresponding to the first order is to be loaded and the second carry apparatus 3 to which the second shipping box (an example of the second order container) corresponding to the second order is to be loaded. The processor 40 may refer to the order table 55 and specify articles which are arranged in the first storage area 101 and which can be moved out to the carry destination WS among the articles which correspond to a plurality of orders allocated to shipping boxes to be loaded onto the plurality of carry apparatuses 3 and which are not placed in the shipping boxes (articles whose the status 601 is picking not completed). With respect to articles corresponding to a plurality of orders, the processor 40 may refer to the inventory table 54 and specify the storage area 101 where the articles are stored (arranged) and refer to the storage area table 57 to specify a WS to which the articles can be moved out. The processor 40 may control the material handling equipment 161 of the first storage area 101 so as to move out the specified articles to the carry destination WS. When articles identified by the same identification information (for example, an article name or an article ID) among the specified articles are articles corresponding to each of the first order and the second order (shared articles) and which are not placed in the first shipping box and the second shipping box, the processor 40 may control the first carry apparatus 3 and the second carry apparatus 3 so that the first carry apparatus 3 and the second carry apparatus 3 arrive at the stop area 164 corresponding to the carry destination WS in an order of a predetermined range (for example, within a predetermined range such as consecutively). With respect to articles identified by the same identification information, the processor 40 can output work instruction information including a quantity which corresponds to a plurality of orders including the first order and the second order and which is a quantity to be picked to the station terminal 710 of the carry destination WS of the first storage area 101. Accordingly, when articles identified by the same identification information are to be picked together or when the articles are to be placed in a plurality of shipping boxes, the carry apparatuses 3 on which the shipping boxes are loaded can be made to arrive consecutively, and it is expected that stagnation of picked articles can be prevented and work efficiency of picking work and loading work can be improved. Note that the articles identified by the same identification information may or may not be picked together.

The first carry apparatus 3 may be loaded with the first shipping box corresponding to the first order and the second shipping box corresponding to the second order. The processor 40 may refer to the order table 55, the inventory table 54, and the storage area table 57 and specify articles which are arranged in the first storage area 101 and which can be moved out to the carry destination WS among the articles which correspond to each of the first order and the second order (shared articles) and which are not placed in the first shipping box and the second shipping box (articles whose the status 601 is picking not completed). The processor 40 may control the material handling equipment 161 of the first storage area 101 so as to move out the specified articles to the carry destination WS. With respect to articles identified by the same identification information (for example, an article name or an article ID) among the specified articles, the processor 40 can output work instruction information including a quantity which corresponds to a plurality of orders including the first order and the second order and which is a quantity to be picked to the station terminal 710 of the carry destination WS of the first storage area 101. Accordingly, for example, in S1629, with respect to articles which correspond to a plurality of orders (the first order and the second order) and which are identified by the same identification information, since the articles can be picked together and loaded to each of a plurality of shipping boxes (first shipping box and second shipping box) to be loaded on a same carry apparatus (first carry apparatus 3), stagnation of the picked articles can be prevented and picking efficiency, loading efficiency, and movement efficiency can be improved.

The processor 40 may refer to the order table 55, the inventory table 54, and the storage area table 57 and specify articles which are arranged in the first storage area 101 and which can be moved out to the carry destination WS among the articles which correspond to an order allocated to one or a plurality of shipping boxes to be loaded onto the same carry apparatus 3 and which are not placed in the shipping boxes (articles whose the status 601 is picking not completed). The processor 40 may control the material handling equipment 161 of the first storage area 101 so that a plurality of articles identified by respectively different pieces of identification information (for example, article names or article IDs) among the specified articles arrive at the carry destination WS in an order of a predetermined range (for example, within a predetermined range such as consecutively). Accordingly, by causing articles to be placed in the shipping boxes (a plurality of articles identified by respectively different pieces of identification information) to arrive consecutively, it is expected that stagnation of picked articles can be prevented and work efficiency of picking work and loading work can be improved.

The processor 40 may refer to the order table 55 and specify that, with respect to articles corresponding to the first order and articles corresponding to the second order among the plurality of orders, articles identified by the same identification information (for example, an article name or an article ID) are at least partially included. With respect to a first shipping box and a second shipping box loaded to the first carry apparatus 3, the processor 40 may allocate the first shipping box to the first order and the second shipping box to the second order. Accordingly, for example, in S1629, with respect to articles which correspond to a plurality of orders (the first order and the second order) and which are identified by the same identification information, since the articles can be picked together and loaded to each of a plurality of shipping boxes (first shipping box and second shipping box) to be loaded on a same carry apparatus (first carry apparatus 3), stagnation of the picked articles can be prevented and picking efficiency, loading efficiency, and movement efficiency can be improved.

The processor 40 may refer to the order table 55 and specify a priority (for example, the priority flag 611) of a plurality of orders. For example, the processor 40 may specify an order with high priority (an order with the priority flag 611 of “present”) among the plurality of orders. The processor 40 may control the material handling equipment 161 of the first storage area 101 so that articles corresponding to an order with a high priority among the plurality of articles scheduled to be moved out from the first storage area 101 to the carry destination WS are moved out to the carry destination WS or arrive at the carry destination WS before at least a part of the articles of an order (an order without the priority flag 611) with a lower priority than the order. Accordingly, efficiency can be improved by reducing a manual workload for high-priority orders such as sudden orders and level of service including responding to sudden orders and meeting work deadlines can be improved.

The processor 40 may refer to the order table 55 and specify a priority (for example, the priority flag 611) of a plurality of orders. For example, the processor 40 may specify an order with high priority (an order with the priority flag 611 of “present”) among the plurality of orders. The processor 40 may control the plurality of carry apparatuses 3 scheduled to move to the stop area 164 corresponding to the carry destination WS so that the carry apparatus 3 loaded with a shipping box corresponding to an order with high priority arrives at the stop area 164 before at least a part of the carry apparatuses 3 loaded with shipping boxes corresponding to lower-priority orders (orders without the priority flag 611) than the order. Accordingly, efficiency can be improved by reducing a manual workload for high-priority orders such as sudden orders and level of service including responding to sudden orders and meeting work deadlines can be improved.

The processor 40 may specify a first WS as a WS to which a part of articles being arranged in the first storage area 101 and corresponding to the second order can be moved out and specify a second WS as a WS to which a part of articles being arranged in the first storage area 101 and corresponding to the second order can be moved out. For example, with respect to each article corresponding to the second order, the processor 40 may refer to the order table 55 and the inventory table 54 and specify the storage area 101 and the position-in-area (position-in-area 705) where the article is stored (arranged) and refer to the storage area table 57 to specify a WS corresponding to the specified position-in-area (position-in-area 804) (WS specified by the station ID 805) to which the article can be moved out. The processor 40 may control the material handling equipment 161 of the first storage area 101 so as to move out a part of articles corresponding to the second order to the first WS. The processor 40 may control the second carry apparatus 3 to which an order container corresponding to the second order is loaded so as to move to the stop area 164 corresponding to the first WS. The processor 40 may control the material handling equipment 161 of the first storage area 101 so as to move out another part of the articles corresponding to the second order to the second WS after the part of articles having been moved out are placed in the order container loaded to the second carry apparatus 3. The processor 40 may control the second carry apparatus 3 so as to move to the stop area 164 corresponding to the second WS. Accordingly, a workload of sorting work can be reduced even when storage positions of a plurality of articles corresponding to an order straddle a plurality of areas in a same storage area.

With respect to a plurality of orders (orders corresponding to articles whose the status 601 is picking not completed) in the order table 55, the processor 40 may determine an order or timing of articles moved out from the material handling equipment 161 of one or a plurality of storage areas 101 so as to improve work efficiency and carry efficiency of the system as a whole. In addition, by referring to the storage area 1106, the target position 1107, and the like of the carry apparatus table 53, an order or timing of articles moved out from the material handling equipment 161 of the storage area 101 with respect to orders corresponding to shipping boxes to be loaded on carry apparatuses 3 which are scheduled to be moved or standing by to move to the movement destination storage area 101 or a WS of the movement destination storage area 101.

Articles corresponding to a given order (voucher number or shipping box group) may be stored (arranged) at a plurality of storage areas 101 or stored (arranged) at one storage area 101. In addition, as shown in the storage area table 57, when a WS to which articles can be moved out from a given storage area 101 is determined in accordance with the position-in-area 804 (a plurality of areas in the same storage area) or the like, articles corresponding to a given order may be moved out from a same WS corresponding to the storage area 101 or moved out from different WSs corresponding to the storage area 101. Therefore, for example, there may be cases where the carry apparatus 3 loaded with a shipping box corresponding to a given order travels to a plurality of storage areas 101 (stop areas 164 of the plurality of storage areas 101) to gather the articles corresponding to the shipping box or the carry apparatus 3 travels to a plurality of WSs (stop areas 164 corresponding to the WSs) that correspond to one storage area to gather the articles corresponding to the shipping box. In this manner, a system is provided which is capable of reducing a workload of sorting work by means of the carry system, the control apparatuses 4, the control method used by the control apparatuses 4, and the like even when storage positions of a plurality of articles corresponding to an order straddle a plurality of areas.

The embodiment described above is applicable to cases where a logistics facility (such as a warehouse or a logistics center) includes at least one or more storage areas 101. In other words, the embodiment described above can also be applied to a system in which the carry apparatus 3 loaded with a shipping box corresponding to an order (voucher number or shipping box group) travels to one or a plurality of WSs (stop areas 164 corresponding to the WSs) that correspond to the one storage area.

For example, the carry system includes a plurality of the carry apparatuses 3 and the control apparatus 4. The first carry apparatus 3 among the plurality of carry apparatuses 3 is loaded with a first shipping box that corresponds to a first order. The storage apparatus 42 of the control apparatus 4 stores inventory information including information about the inventory of articles arranged in the storage area 101. The storage area 101 includes a plurality of WSs and a plurality of stop areas 164 (one or more stop areas corresponding to each WS). Each of the plurality of WSs is a work station being an area that may become an outbound movement destination of articles from the storage area to which the WS is associated and where work of picking the moved articles and/or placing the picked articles into an order container is performed. Each of the plurality of stop areas 164 is an area where the carry apparatuses 3 stop. The storage area 101 includes the material handling equipment 161 (for example, the automated warehouse 161B).

With respect to each of a plurality of articles corresponding to the first order, the processor 40 of the control apparatus 4 refers to the inventory table 54 (inventory information) and specifies the position-in-area 705 and refers to the storage area table 57 to specify a WS (WS specified by the station ID 805) to which the article can be moved out from the specified position-in-area. For example, the processor 40 specifies a first WS as a WS to which a part of articles corresponding to the first order can be moved out (or a WS from which articles are moved out) and specify a second WS as a WS to which another part of articles corresponding to the first order can be moved out (or a WS from which articles are moved out). The processor 40 selects the first WS to which a part of the articles corresponding to the first order can be moved out among the two or more specified WSs to which articles can be moved out. The processor 40 controls the material handling equipment 161 so as to move out a part of articles corresponding to the first order to the first WS. The processor 40 controls the first carry apparatus 3 to which the first shipping box corresponding to the first order is loaded so as to move to the stop area 164 corresponding to the first WS. The processor 40 controls the material handling equipment 161 so as to move out another part of the articles corresponding to the first order to the second WS after the part of articles having been moved out are placed in the first shipping box loaded to the first carry apparatus 3. The processor 40 controls the first carry apparatus 3 so as to move the other part of the articles corresponding to the first order to the stop area 164 corresponding to the second WS to which articles can be moved out.

In addition, a control method by the control apparatus 4 (the processor 40 of the control apparatus 4) which controls the carry apparatus 3 loaded with a shipping box (an example of an order container) corresponding to an order and the material handling equipment 161 in the storage area 101 includes the step of having the control apparatus 4 specify a work station (WS) to which articles which are arranged in the storage area 101 and which correspond to the order to be moved out. In addition, the control method includes the step of having the control apparatus 4 control the material handling equipment 161 so as to move out a part of articles corresponding to the order from the storage area 101 to a first WS that is a WS to which the articles can be moved out, and control the carry apparatus loaded with the shipping box so that the carry apparatus moves to the stop area 164 corresponding to the first WS. Furthermore, the control method includes the step of having the control apparatus 4 control the material handling equipment 161 so as to move out another part of articles corresponding to the order from the storage area 101 to a second WS that is a WS to which the articles can be moved out after the part of article having been moved out is placed in the shipping box loaded on the carry apparatus 3, and control the carry apparatus 3 loaded with the shipping box so that the carry apparatus 3 moves to the stop area 164 corresponding to the second WS. Since articles of a same shipping unit (packing unit) are placed in the shipping box corresponding to the order, there is no need to sort the articles in the shipping box. Accordingly, a workload of sorting work can be reduced even when storage positions of a plurality of articles corresponding to an order straddle a plurality of areas (areas in one or a plurality of storage areas).

[Reference Signs List]

3: carry apparatus, 4: control apparatus

1. A control apparatus, comprising: an interface apparatus; a storage apparatus; and a processor coupled to the interface apparatus and the storage apparatus, wherein
the storage apparatus stores inventory information including information about the inventory of articles arranged in each of a plurality of storage areas that differ in at least one of a storage scheme, an outbound movement scheme, and a picking scheme,
each of the plurality of storage areas includes one or more work stations (WSs) and one or more stop areas,
each of the one or more WSs is an area that can become an outbound movement destination of articles from the storage area to which the WS is associated and where work of picking the moved articles and/or placing the picked articles into an order container is performed,
each of the one or more stop areas is an area where carry apparatuses stop,
one or more storage areas among the plurality of storage areas include material handling equipment,
the interface apparatus communicates with the material handling equipment of the one or more storage areas and a plurality of carry apparatuses including a first carry apparatus on which a first order container corresponding to a first order is loaded,
when the processor specifies from the inventory information that a plurality of articles corresponding to the first order are arranged in two or more storage areas among the plurality of storage areas, the processor:
selects a first storage area where a part of the articles corresponding to the first order are arranged among the two or more specified storage areas;
controls the material handling equipment of the first storage area so as to move out the part of the articles corresponding to the first order from the first storage area;
specifies a carry destination WS that is a WS to which the part of the articles are moved out;
controls the first carry apparatus to which a first order container corresponding to the first order is loaded so as to move to a stop area corresponding to the carry destination WS; and
after the part of articles having moved out are placed in the first order container loaded on the first carry apparatus, controls the first carry apparatus so as to move to a stop area corresponding to a second storage area in which another part of the articles corresponding to the first order is arranged.

2. The control apparatus according to claim 1, wherein with respect to each of two or more orders including the first order, when articles corresponding to the order include articles arranged in the first storage area, the processor:
controls the material handling equipment of the first storage area so as to move out two or more articles corresponding to the two or more orders to the carry destination WS and specifies an order in which the two or more articles arrive at the carry destination WS; and
controls two or more carry apparatuses including the first carry apparatus so that, with respect to each of two or more orders, an order of arrival at a stop area corresponding to the carry destination WS by carry apparatus on which an order container corresponding to the order is loaded matches the order in which the articles corresponding to the order arrive at the carry destination WS.

3. The control apparatus according to claim 1, wherein the processor:
specifies a timing at which a part of the articles corresponding to the first order are moved out and arrive at the carry destination WS or a timing at which the articles are picked at the carry destination WS; and
controls the first carry apparatus so that the first carry apparatus on which the first order container corresponding to the first order is loaded arrives at the stop area corresponding to the carry destination WS so as to coincide with the specified timing.

4. The control apparatus according to claim 1, wherein with respect to each of two or more orders including the first order, when articles corresponding to the order include articles arranged in the first storage area, the processor:
specifies, with respect to each of the two or more orders, an order in which carry apparatuses loaded with order containers corresponding to the order arrive at a stop area corresponding to the carry destination WS; and
controls, with respect to each of the two or more orders, the material handling equipment of the first storage area to move out the articles corresponding to the order to the carry destination WS so that an order in which the articles corresponding to the order arrive at the carry destination WS matches the order in which the carry apparatuses on which order containers corresponding to the order are loaded arrive at the stop area corresponding to the carry destination WS.

5. The control apparatus according to claim 1, wherein
the processor:
specifies a timing at which the first carry apparatus on which the first order container corresponding to the first order is loaded arrives at a stop area corresponding to the carry destination WS; and
controls the material handling equipment of the first storage area so that the part of articles corresponding to the first order arrives at the carry destination WS so as to coincide with the specified timing.

6. The control apparatus according to claim 1, wherein the processor:
specifies a WS to which articles corresponding to a plurality of orders can be moved out;
with respect to articles corresponding to the first order and articles corresponding to a second order, specifies that articles which can be moved out to a same WS are at least partially included;
with respect to the first order container and a second order container to be loaded to the first carry apparatus, allocates the first order container to the first order and allocates the second order container to the second order;
controls the material handling equipment of the first storage area so that articles that can be moved out to the same WS are moved out to a carry destination WS that is a WS to which the articles can be moved out from the first storage area where the articles are arranged;
controls the first carry apparatus to which the first order container and the second order container are loaded so as to move to a stop area corresponding to the carry destination WS; and
with respect to articles that can be moved out to the same WS, outputs work instruction information including a quantity of the articles in the first order and which is a quantity to be placed in the first order container and work instruction information including a quantity of the articles in the second order and which is a quantity to be placed in the second order container to a station terminal of a carry destination WS of the first storage area.

7. The control apparatus according to claim 1, wherein the processor:
with respect to each of one or two or more storage areas at which articles not placed in the first order container corresponding to the first order among the plurality of articles corresponding to the first order, specifies a state at the storage area or a state at a WS of the storage area; and
determines a target position corresponding to a storage area to become a movement destination among the one or two or more storage areas based on at least the specified state and controls the first carry apparatus so as to move to the determined target position.

8. The control apparatus according to claim 1, wherein the processor:
with respect to a first article and a second article which are articles not placed in the first order container corresponding to the first order, specifies a state of a work task at each of a first WS where work for placing the first article in the first order container is performed and a second WS where work for placing the second article in the first order container is performed; and
controls the first carry apparatus to move to the second WS whose work task is less than that of the first WS based on at least the specified states of the work task.

9. The control apparatus according to claim 1, wherein the processor:
with respect to a first article and a second article which are articles not placed in the first order container corresponding to the first order, specifies a standby state of a carry apparatus corresponding to each of a first WS where work for placing the first article in the first order container is performed and a second WS where work for placing the second article in the first order container is performed; and
controls the first carry apparatus to move to the second WS at which the number of carry apparatuses on standby is smaller than that at the first WS based on at least the specified standby states of the carry apparatuses.

10. The control apparatus according to claim 1, wherein the processor:
when moving out a part of the articles corresponding to the first order from the first storage area, specifies a state of a work task at each of the first WS and the second WS that are WSs to which the part of the articles can be moved out; and
determines the second WS whose work task is less than that of the first WS as the carry destination WS being a WS to which the part of articles is to be moved out based on at least the specified states of the work task.

11. The control apparatus according to claim 1, wherein the processor:
when moving out a part of the articles corresponding to the first order from the first storage area, specifies a standby state of carry apparatuses corresponding to each of a first WS and a second WS that are WSs to which the part of the articles can be moved out; and
determines the second WS at which the number of carry apparatuses on standby is smaller than that at the first WS based on at least the specified standby states of the carry apparatuses as the carry destination WS that is a WS to which the part of articles is to be moved out.

12. The control apparatus according to claim 1, wherein when the first storage area has a temporary standby area in addition to the stop area, the processor:
controls the first carry apparatus so as to move to the temporary standby area; and
after the first carry apparatus arrives at the temporary standby area or after the first carry apparatus starts to move toward the temporary standby area, controls the material handling equipment of the first storage area so as to move out the part of articles to the carry destination WS.

13. The control apparatus according to claim 1, wherein the processor determines whether to load a plurality of order containers or one order container onto the first carry apparatus based on at least a size of the order container; and
one of the one or a plurality of determined order containers is the first order container.

14. The control apparatus according to claim 1, wherein the processor determines whether to load a plurality of order containers or one order container onto the first carry apparatus based on at least a work deadline of the first order.

15. The control apparatus according to claim 1, wherein
the interface apparatus communicates with a station terminal that is an information processing terminal provided in relation with a WS,
the processor controls the material handling equipment of the first storage area to move out the part of the articles to the carry destination WS of the first storage area before the first carry apparatus arrives at a stop area corresponding to the carry destination WS,
the processor instructs a station terminal of the carry destination WS of the first storage area to pick the articles moved out to the carry destination WS, and
when a movement destination storage area of the first carry apparatus is the second storage area, the processor instructs the station terminal of a WS of the second storage area to pick the articles after the first carry apparatus arrives at the stop area corresponding to the WS of the second storage area.

16. The control apparatus according to claim 1, wherein
the storage apparatus stores storage area information including information representing a scheme of outbound movement or picking for each storage area,
when the processor specifies from the storage area information that the scheme corresponding to the movement destination storage area is a scheme of picking articles moved out to the carry destination WS by the material handling equipment, the processor controls the material handling equipment so as to move out the articles to the carry destination WS of the movement destination storage area before the carry apparatus arrives at a stop area corresponding to the carry destination WS of the movement destination storage area and instructs the station terminal of the carry destination WS of the movement destination storage area to pick the articles having been moved out to the carry destination WS, and
when the processor specifies from the storage area information that the scheme corresponding to the movement destination storage area is a scheme of having a worker pick articles from a storage position, the processor instructs the station terminal of a WS of the movement destination storage area to pick the articles after the carry apparatus arrives at the stop area corresponding to the WS of the movement destination storage area.

17. The control apparatus according to claim 1, wherein the processor:
with respect to articles to be moved out from the first storage area, outputs work instruction information including a quantity of articles to be picked to the station terminal of the carry destination WS of the first storage area; and
with respect to the articles having been moved out from the first storage area and picked, outputs, to the station terminal of the carry destination WS of the first storage area, work instruction information including the quantity of articles to be placed in the order container loaded onto the carry apparatus having arrived at a stop area corresponding to the carry destination WS.

18. The control apparatus according to claim 17, wherein the processor:
with respect to articles which correspond to a plurality of orders including the first order and a second order and which are to be moved out from the first storage area, outputs work instruction information including a quantity which corresponds to the plurality of orders and which is a quantity to be picked to the station terminal of the carry destination WS of the first storage area;
with respect to the articles having been moved out from the first storage area and picked, outputs, to the station terminal of the carry destination WS of the first storage area, work instruction information including the quantity of articles to be placed in the first order container loaded onto the first carry apparatus having arrived at a stop area corresponding to the carry destination WS and which is the quantity of articles in the first order corresponding to the first order container; and
the quantity of articles to be picked which is a quantity corresponding to the plurality of orders is larger than the quantity of the articles in the first order corresponding to the first order container.

19. The control apparatus according to claim 18, wherein the processor:
with respect to a plurality of carry apparatuses including the first carry apparatus loaded with the first order container corresponding to the first order and a second carry apparatus loaded with a second order container corresponding to the second order, specifies articles which are arranged in the first storage area and which can be moved out to the carry destination WS among articles which correspond to a plurality of orders allocated to order containers to be loaded onto the plurality of carry apparatuses and which are not placed in the order containers;
controls the material handling equipment of the first storage area so as to move out the specified articles to the carry destination WS;
when articles identified by same identification information among the specified articles are articles corresponding to each of the first order and the second order and which are not placed in the first order container and the second order container, controls the first carry apparatus and the second carry apparatus so that the first carry apparatus and the second carry apparatus arrive at a stop area corresponding to the carry destination WS in an order of a predetermined range; and
with respect to articles identified by the same identification information, outputs work instruction information including a quantity which corresponds to a plurality of orders including the first order and the second order and which is a quantity to be picked to the station terminal of the carry destination WS of the first storage area.

20. The control apparatus according to claim 18, wherein
the first carry apparatus is loaded with the first order container corresponding to the first order and the second order container corresponding to the second order, and
the processor: specifies articles which are arranged in the first storage area and which can be moved out to the carry destination WS among articles which correspond to each of the first order and the second order and which are not placed in the first order container and the second order container;
controls the material handling equipment of the first storage area so as to move out the specified articles to the carry destination WS; and
with respect to articles identified by the same identification information among the specified articles, outputs work instruction information including a quantity which corresponds to a plurality of orders including the first order and the second order and which is a quantity to be picked to the station terminal of the carry destination WS of the first storage area.

21. The control apparatus according to claim 1, wherein the processor:
specifies articles which are arranged in the first storage area and which can be moved out to the carry destination WS among articles which correspond to an order allocated to one or a plurality of order containers loaded onto a same carry apparatus and which are not placed in the order containers; and
controls the material handling equipment of the first storage area so that a plurality of articles identified by respectively different pieces of identification information among the specified articles arrive at the carry destination WS in an order of a predetermined range.

22. The control apparatus according to claim 1, wherein the processor:
specifies that, with respect to articles corresponding to the first order and articles corresponding to the second order among the plurality of orders, articles identified by the same identification information are at least partially included; and
with respect to the first order container and a second order container to be loaded to the first carry apparatus, allocates the first order container to the first order and allocates the second order container to the second order.

23. The control apparatus according to claim 1, wherein the processor:
specifies a priority of a plurality of orders; and
controls the material handling equipment of the first storage area so that articles corresponding to an order with a high priority among the plurality of articles scheduled to be moved out from the first storage area to the carry destination WS are moved out to the carry destination WS or arrives at the carry destination WS before at least a part of the articles of an order with a lower priority than the order.

24. The control apparatus according to claim 1, wherein the processor:
specifies a priority of a plurality of orders; and
controls the plurality of carry apparatuses scheduled to move to a stop area corresponding to the carry destination WS so that a carry apparatus loaded with an order container corresponding to an order with high priority arrives at the stop area before at least a part of carry apparatuses loaded with order containers corresponding to lower-priority orders than the order.

25. The control apparatus according to claim 1, wherein the processor:
specifies a first WS as a WS to which a part of articles being arranged in the first storage area and corresponding to a second order can be moved out and specify a second WS as a WS to which another part of articles being arranged in the first storage area and corresponding to the second order can be moved out;
controls the material handling equipment of the first storage area so as to move out the part of the articles corresponding to the second order to the first WS;
controls the second carry apparatus to which an order container corresponding to the second order is loaded so as to move to a stop area corresponding to the first WS;
controls the material handling equipment of the first storage area so as to move out another part of the articles corresponding to the second order to the second WS after the part of articles having been moved out are placed in the order container loaded to the second carry apparatus; and
controls the second carry apparatus so as to move to a stop area corresponding to the second WS.

26. A carry system, comprising a plurality of carry apparatuses and a control apparatus, wherein
a first carry apparatus among the plurality of carry apparatuses is loaded with a first order container that corresponds to a first order,
the control apparatus stores inventory information including information about the inventory of articles arranged in each of a plurality of storage areas that differ in at least one of a storage scheme, an outbound movement scheme, and a picking scheme,
each of the plurality of storage areas includes one or more work stations (WSs) and one or more stop areas,
each of the one or more WSs is an area that may become an outbound movement destination of articles from the storage area to which the WS is associated and where work of picking the moved articles and/or placing the picked articles into an order container is performed,
each of the one or more stop areas is an area where carry apparatuses stop,
one or more storage areas among the plurality of storage areas include material handling equipment,
when the control apparatus specifies from the inventory information that a plurality of articles corresponding to the first order are arranged in two or more storage areas among the plurality of storage areas, the control apparatus:
selects a first storage area where a part of the articles corresponding to the first order are arranged among the two or more specified storage areas;
controls the material handling equipment of the first storage area so as to move out the part of the articles corresponding to the first order from the first storage area;
specifies a carry destination WS that is a WS to which the part of the articles are moved out;
controls the first carry apparatus to which a first order container corresponding to the first order is loaded so as to move to a stop area corresponding to the carry destination WS; and
after the part of articles having moved out are placed in the first order container loaded on the first carry apparatus, controls the first carry apparatus so as to move to a stop area corresponding to a second storage area in which another part of the articles corresponding to the first order is arranged.

27. A carry system, comprising a plurality of carry apparatuses and a control apparatus, wherein
a first carry apparatus among the plurality of carry apparatuses is loaded with a first order container that corresponds to a first order,
the control apparatus stores inventory information including information about the inventory of articles arranged in each of a plurality of storage areas that differ in at least one of a storage scheme, an outbound movement scheme, and a picking scheme,
each of the plurality of storage areas includes one or more work stations (WSs) and one or more stop areas,
each of the one or more WSs is an area that can become an outbound movement destination of articles from the storage area to which the WS is associated and where work of picking the moved articles and/or placing the picked articles into an order container is performed,
each of the one or more stop areas is an area where carry apparatuses stop,
one or more storage areas among the plurality of storage areas include material handling equipment,
when the control apparatus specifies from the inventory information that a plurality of articles corresponding to the first order are arranged in two or more storage areas among the plurality of storage areas, the control apparatus:
controls the first carry apparatus so as to move to a stop area corresponding to a second storage area where a part of the articles corresponding to the first order are arranged among the two or more specified storage areas;
controls the material handling equipment of the first storage area so as to move out another part of the articles corresponding to the first order from the first storage area where the other part of the articles corresponding to the first order are arranged after the part of articles are placed in the first order container loaded to the first carry apparatus;
specifies a carry destination WS that is a WS to which the other part of the articles are moved out; and
controls the first carry apparatus to which a first order container corresponding to the first order is loaded so as to move to a stop area corresponding to the carry destination WS.

28. A control method by a control apparatus which controls a carry apparatus to which an order container corresponding to an order is to be loaded and material handling equipment of a storage area, the control method comprising the steps of:
having the control apparatus specify a work station (WS) to which articles which are arranged in the storage area and which correspond to the order can be moved out;
having the control apparatus control the material handling equipment so as to move out a part of articles corresponding to the order from the storage area to a first WS that is a WS to which the articles can be moved out, and control the carry apparatus loaded with the order container so that the carry apparatus moves to a stop area corresponding to the first WS; and
having the control apparatus control the material handling equipment so as to move out another part of articles corresponding to the order from the storage area to a second WS that is a WS to which the articles can be moved out after the part of articles having been moved out is placed in the order container loaded on the carry apparatus, and control the carry apparatus loaded with the order container so that the carry apparatus moves to a stop area corresponding to the second WS.
